(19) United States
(12) Patent Application Publication
(10) Pub. No.: US 2019/0341783 A1
(43) Pub. Date: Nov. 7, 2019

(54) DETERMINATION APPARATUS, SURVEILLANCE APPARATUS, ENERGY STORAGE SYSTEM, SURVEILLANCE SYSTEM, DETERMINATION METHOD, SURVEILLANCE METHOD, OPERATION METHOD OF ENERGY STORAGE SYSTEM, AND NON-TRANSITORY STORAGE MEDIUM

(71) Applicant: NEC Corporation, Tokyo (JP)

(72) Inventors: Shinichiro KOSUGI, Tokyo (JP); Hiroshi HANAFUSA, Tokyo (JP); Hideki TANABE, Tokyo (JP); Yusuke MORI, Tokyo (JP)

(73) Assignee: NEC Corporation, Tokyo (JP)

(21) Appl. No.: 16/315,748

(22) PCT Filed: Jul. 3, 2017
(86) PCT No.: PCT/JP2017/024351

§ 371 Date: Jan. 7, 2019

(30) Foreign Application Priority Data
Jul. 15, 2016 (JP) 2016-140567

(51) Int. Cl. H02J 3/46; H02J 13/00; H02J 7/00

(52) U.S. Cl. CPC H02J 3/46; H02J 13/0003; G06Q 50/06; H02J 2007/0001; H02J 7/0026

(57) ABSTRACT

The present invention provides a determination apparatus (10) including a regular information obtaining unit (11) (information obtaining unit) that obtains first information indicating plural components, included in an energy storage system, associated with each energy storage system, an object information obtaining unit (12) that obtains object information indicating the plural components included in the energy storage system to be verified; and a determination unit (13) that determines whether or not a configuration of the energy storage system to be verified is regular on the basis of the first information and the object information.

### TECHNICAL FIELD

The present invention relates to a determination apparatus, a surveillance apparatus, an energy storage system, a surveillance system, a determination method, a surveillance method, an operation method of the energy storage system, and a program.

### BACKGROUND ART

Patent Document 1 discloses a group electric power management apparatus which obtains information of an electric power storage amount for each of plural electric power storage apparatuses from plural controllers provided for each of the electric power storage apparatuses and manages the information of the electric power storage amount for each of groups.

Patent Document 2 discloses a manager server which compares, when device information of a server or a client is received from the server or the client, the device information received this time with the device information received previous time and displays a change status in a case where a change occurs. The device information includes a manufacturing number, a host name, an IP address, an address of an installation place, an administrator, a contact address, and the like.

### RELATED DOCUMENT

### Patent Document

[Patent Document 1] Japanese Patent Application Publication No. 2011-155714

[Patent Document 2] Japanese Patent Application Publication No. 2009-169580

### SUMMARY OF THE INVENTION

### Technical Problem

The energy storage system storing energy such as electric power or the like is configured to include plural components. For example, the energy storage system is configured to include a system controller which controls an overall system, an energy storage unit which stores energy, an energy control unit which controls the energy storage unit, a power conditioner which performs conversion of DC power/AC power, and the like.

If a combination of the plural components is out of a normal state due to system remodeling or the like, there is a possibility that a value, safety, and the like of the energy storage system are damaged. Any of the inventions according to Patent Documents 1 and 2 does not provide such a problem and solutions for the problem.

An object of the present invention is to provide a technology for detecting that a combination of plural components of an energy storage system is out of a regular state.

### Solution to Problem

According to the present invention, there is provided a determination apparatus including: an information obtaining unit that obtains first information indicating plural components, included in an energy storage system, associated with each energy storage system; an object information obtaining unit that obtains object information indicating the plural components included in the energy storage system to be verified; and a determination unit that determines whether or not a configuration of the energy storage system to be verified is regular on the basis of the first information and the object information.

In addition, according to the present invention, there is provided a surveillance apparatus including: an obtaining unit that obtains object information indicating plural components included in an energy storage system to be verified; and a communication unit that transmits the object information to an external apparatus.

In addition, according to the present invention, there is provided an energy storage system including plural components, and transmitting object information indicating each of the components to an external apparatus at a predetermined timing.

In addition, according to the present invention, there is provided a surveillance system including the determination apparatus and the surveillance apparatus.

In addition, according to the present invention, there is provided a determination method performed by a computer, the method including: an information obtaining step of obtaining first information indicating plural components, included in an energy storage system, associated with each energy storage system; an object information obtaining step of obtaining object information indicating the plural components included in the energy storage system to be verified; and a determination step of determining whether or not a configuration of the energy storage system to be verified is regular on the basis of the first information and the object information.

In addition, according to the present invention, there is provided a program causing a computer to function as: an information obtaining unit that obtains first information indicating plural components, included in an energy storage system, associated with each energy storage system; an object information obtaining unit that obtains object information indicating the plural components included in the energy storage system to be verified; and a determination unit that determines whether or not a configuration of the energy storage system to be verified is regular on the basis of the first information and the object information.

In addition, according to the present invention, there is provided a surveillance method performed by a computer, the method including: an obtaining step of obtaining object information indicating plural components included in an energy storage system to be verified; and a communication step of transmitting the object information to an external apparatus.

In addition, according to the present invention, there is provided a program causing a computer to function as: an obtaining unit that obtains object information indicating plural components included in an energy storage system to be verified; and a communication unit that transmits the object information to an external apparatus.

In addition, according to the present invention, there is provided an operation method of an energy storage system performed by a computer of the energy storage system including plural components, the method including transmitting object information indicating each of the components to an external apparatus at a predetermined timing.

In addition, according to the present invention, there is provided a program causing a computer of an energy storage system including plural components, to function as a unit that transmits object information indicating each of the components to an external apparatus at a predetermined timing.

### Advantageous Effects of Invention

According to the present invention, a technology for detecting that a combination of plural components of an energy storage system is out of a regular state is realized.

### BRIEF DESCRIPTION OF THE DRAWINGS

The above objects and other objects, features and advantages will become more apparent from the following description of the preferred example embodiments and the accompanying drawings.

FIG. 1 is a diagram conceptually illustrating an example of a hardware configuration of an apparatus according to the present example embodiment.

FIG. 2 is an example of a functional block diagram illustrating an overview of a surveillance system according to the present example embodiment.

FIG. 3 is an example of a functional block diagram of an energy storage system according to the present example embodiment.

FIG. 4 is an example of a functional block diagram illustrating a surveillance apparatus according to the present example embodiment.

FIG. 5 is an example of a functional block diagram illustrating a determination apparatus according to the present example embodiment.

FIG. 6 is a diagram schematically illustrating an example of information stored in a regular information storage unit according to the present example embodiment.

FIG. 7 is a diagram schematically illustrating another example of the information stored in the regular information storage unit according to the present example embodiment.

FIG. 8 is a sequence diagram illustrating an example of a flow of a process of the surveillance system according to the present example embodiment.

FIG. 9 is a sequence diagram illustrating another example of the flow of the process of the surveillance system according to the present example embodiment.

FIG. 10 is a sequence diagram illustrating still another example of the flow of the process of the surveillance system according to the present example embodiment.

FIG. 11 is a diagram schematically illustrating an example of information for identifying a component on the basis of charge and discharge characteristics.

FIG. 12 is an example of a functional block diagram illustrating the determination apparatus according to the present example embodiment.

FIG. 13 is a flowchart illustrating an example of a flow of a process of the determination apparatus according to the present example embodiment.

FIG. 14 is a flowchart illustrating another example of the flow of the process of the determination apparatus according to the present example embodiment.

### DESCRIPTION OF EMBODIMENTS

First, examples of hardware configurations of apparatuses (determination apparatus, surveillance apparatus, and energy storage system) of the present example embodiment will be described. Each of units included in the apparatus of the present example embodiment can be configured with any combination of hardware and software on the basis of a central processing unit (CPU) of a certain computer, a memory, a program loaded in the memory, a storage unit (in addition to the program stored from a stage of shipping the apparatus in advance, a program downloaded from a storage medium such as a compact disc (CD) or a server on the internet) such as a hard disc storing the program, and a network connection interface. Those skilled in the art understand that there are various modifications to a configuration method and the apparatus.

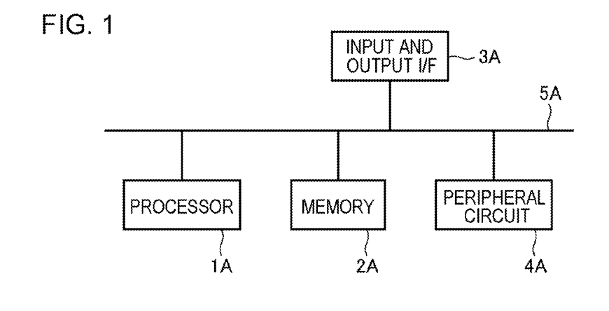

FIG. 1 is a block diagram illustrating a hardware configuration of the apparatus of the present example embodiment. As illustrated in FIG. 1, the apparatus includes a processor 1A, a memory 2A, an input and output interface 3A, a peripheral circuit 4A, and a bus 5A. The peripheral circuit 4A includes various modules. Note that, the apparatus may not include the peripheral circuit 4A.

The bus 5A is a data transmission path through which the processor 1A, the memory 2A, the peripheral circuit 4A and, the input and output interface 3A transmit and receive data from one another. The processor 1A is an arithmetic processing device such as a central processing unit (CPU) or a graphics processing unit (GPU). The memory 2A is a memory such as a random access memory (RAM) or a read only memory (ROM), for example. The input and output interface 3A includes an interface for obtaining information from an input devise (for example, keyboard, mouse, microphone, or the like), an external apparatus, an external server, an external sensor, and the like and an interface for outputting the information from an output devise (for example, display, speaker, printer, mailer, or the like), the external apparatus, the external server, and the like. The processor 1A can issue a command to each of the modules and perform a calculation on the basis of a calculation result thereof.

Hereinafter, the present example embodiment will be described. Note that, the functional block diagram used in the description of the example embodiment below is not a hardware unit configuration but a block of a functional unit. In these drawings, it is described that each of apparatuses is realized by one apparatus, but a unit for realizing the apparatus is not limited to thereto. That is, the apparatus may have a physically separated configuration or a logically divided configuration. Note that, the same components are denoted by the same reference numerals, and description thereof will not be repeated as appropriate.

Note that, in the present specification, “obtaining” means at least one of that an apparatus receives data or information stored in another apparatus or a storage medium (active obtaining), for example, that the own apparatus receives data or information by requesting or inquiring the other apparatus, the own apparatus reads data or information by accessing to the other apparatus or the storage medium, or data or information output from another is input to an apparatus (passive obtaining), and for example, the own apparatus receives distributed (or transmitted, notified to be pushed, or the like) data or information. In addition, “obtaining” also includes selecting and obtaining from the received data or information, or selecting and receiving the distributed data or information.

### First Example Embodiment

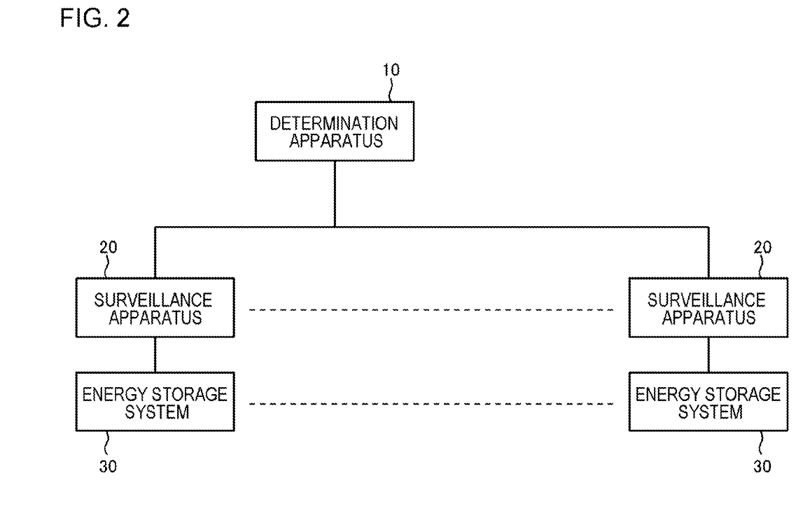

First, with reference to FIG. 2, an overview of a surveillance system according to the present example embodiment will be described. As illustrated, the surveillance system includes a determination apparatus 10, plural surveillance apparatuses 20, and plural energy storage systems 30.

The energy storage system 30 is a system for storing and outputting energy such as electric power and corresponds to, for example, an electric power storage system. The energy storage system 30 is installed in, for example, an area of a consumer.

The surveillance apparatus 20 is installed corresponding to each of the energy storage systems 30 and surveils an operation and a state of the corresponding energy storage system 30. The surveillance apparatus 20 is installed in, for example, the area of the consumer.

The corresponding surveillance apparatus 20 and the energy storage system 30 transmit and receive data from each other by any means (communication means). Note that, the surveillance apparatus 20 and the energy storage system 30 may be integrated physically and/or logically or may be configured separately.

The determination apparatus 10 receives information on the corresponding energy storage system 30 from each of the plural surveillance apparatuses 20. Then, the determination apparatus 10 manages a configuration of each of the energy storage systems 30 on the basis of the received information.

The determination apparatus 10 may control an operation of the energy storage system 30. That is, on the basis of the configuration of the energy storage system 30, the determination apparatus 10 may determine whether or not to permit the operation of the energy storage system 30 and may notify a determination result. In this case, in a case of receiving permission to operate from the determination apparatus 10, the energy storage system 30 can operate and in a case of not receiving the permission to operate, the energy storage system 30 cannot operate.

The determination apparatus 10 may be, for example, a cloud server. The determination apparatuses 10 and each of the plural surveillance apparatuses 20 transmit and receive data with each other through a communication network such as the internet. Note that, each of the plural energy storage systems 30 may also be connected to the communication network such as the internet.

Hereinafter, detailed configurations of the energy storage system 30, the surveillance apparatus 20, and the determination apparatus 10 will be described in this order.

The energy storage system 30 is a system (for example, electric power storage system) for storing energy such as electric power, and is configured to include plural components (plural units) physically and/or logically separated. Hereinafter, in a case where “component” is simply referred, “component” means the plural components provided in the energy storage system 30.

Each of components includes a unit which stores information (for example, model number of unit, manufacturer, date of manufacture, identification number, version of installed software, or the like, and hereinafter, “component ID (identifier)”.) for identifying the own component and a unit which reads the stored component ID and transmits the component ID to the surveillance apparatus 20. The communication means between each of the plural components and the surveillance apparatus 20 is not particularly limited, and any means can be adopted.

Each of the components may further include a unit for receiving a request for a component ID from the surveillance apparatus 20. When receiving the component ID request from the surveillance apparatus 20, each of the components may return the component ID to the surveillance apparatus 20 in response to the request.

In addition to, each of the components may transmit the component ID to the surveillance apparatus 20 according to an instruction from the component (any one of the plural components included in the energy storage system 30) which controls the overall energy storage system 30. For example, the component which controls the overall energy storage system 30 may further include a unit for detecting that a predetermined timing reaches and a unit for transmitting an instruction causing each of the plural components to transmit the component ID to the surveillance apparatus 20 according to the detection. The component which controls the overall energy storage system 30 may transmit the own component ID to the surveillance apparatus 20 according to the transmission of the instruction. In addition, when receiving the instruction, the other component of the energy storage system 30 may transmit the component ID to the surveillance apparatus 20 according to the instruction.

An example of the predetermined timing includes “timing when the energy storage system 30 is powered ON”, “timing when an instruction input for operating the energy storage system 30 is accepted in a state in which operation permission is not received from the determination apparatus 10”, “timing when an instruction input for operating the energy storage system 30 is accepted regardless of whether or not the operation permission is received”, “timing when a predetermined date and time (for example, 0 o'clock on 1st every month) arrives in a state where the operation permission is received from the determination apparatus 10”, “timing when the operation permission is applied (timing when the energy storage system 30 accepts an application input of the operation permission, timing when the surveillance apparatus 20 receives the application input from the corresponding energy storage system 30, and timing when the determination apparatus 10 receives the application from the surveillance apparatus 20)”, or the like, but the example is not limited thereto.

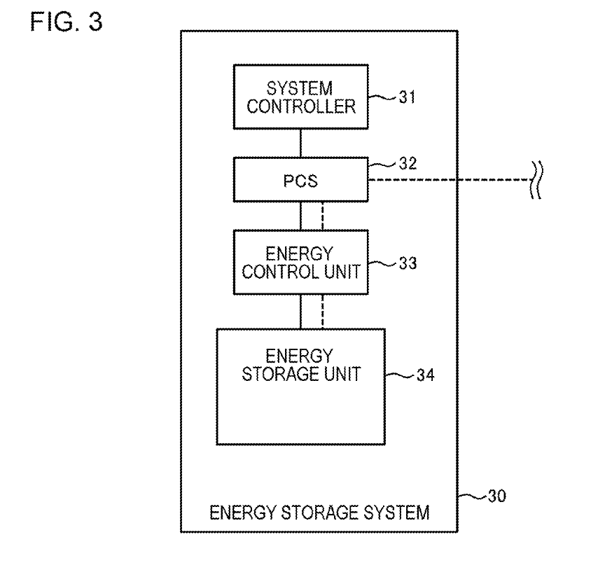

Here, an example of the energy storage system 30 will be described with reference to FIG. 3. As illustrated, the energy storage system 30 includes a system controller 31, a power conditioning system (PCS) 32, an energy control unit 33, and an energy storage unit 34 as the plural components. In the drawing, a communication line is indicated by a solid line and an electric power line is indicated by a dotted line.

The system controller 31 controls the overall energy storage system 30. The PCS 32 performs conversion of DC power/AC power. The energy storage unit 34 stores energy (for example, electric power). The energy storage unit 34 may include, for example, a cell stack which stores energy, a battery monitor which monitors a cell temperature, a voltage, and the like. The energy control unit 33 controls the energy storage unit 34. The energy control unit 33 is a so-called battery management unit (BMU), a battery management system (BMS), or the like.

As described above, each of the system controller 31, the PCS 32, the energy control unit 33, and the energy storage unit 34 includes a unit which stores the component ID for identifying each of the system controller 31, the PCS 32, the energy control unit 33, and the energy storage unit 34 and a unit which reads the stored component ID and transmits the component ID to the surveillance apparatus 20.

Each of the system controller 31, the PCS 32, the energy control unit 33, and the energy storage unit 34 may further include a unit which receives a request for the component ID from the surveillance apparatus 20. When receiving the component ID request from the surveillance apparatus 20, each of the system controller 31, the PCS 32, the energy control unit 33, and the energy storage unit 34 may return the component ID to the surveillance apparatus 20 in response to the request.

In addition, the system controller 31 may further include a unit for detecting that a predetermined timing reaches and a unit for transmitting an instruction causing each of the PCS 32, the energy control unit 33, and the energy storage unit 34 to transmit the component ID to the surveillance apparatus 20 according to the detection. The system controller 31 may transmit the own component ID to the surveillance apparatus 20 according to the transmission of the instruction. In addition, when receiving the instruction, each of the PCS 32, the energy control unit 33, and the energy storage unit 34 may transmit the component ID to the surveillance apparatus 20 according to the instruction.

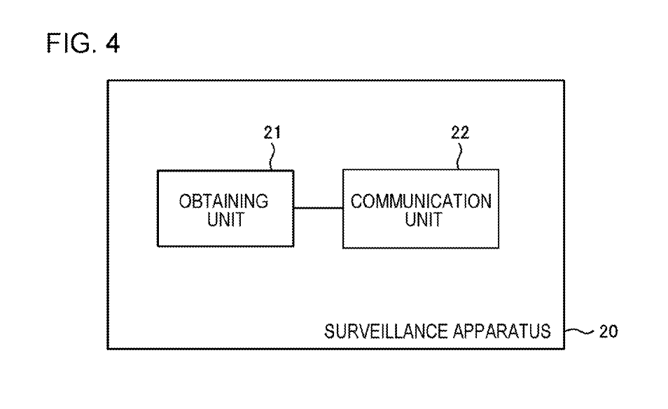

Next, the surveillance apparatus 20 will be described. FIG. 4 is an example of a functional block diagram of the surveillance apparatus 20. As illustrated, the surveillance apparatus 20 includes an obtaining unit 21 and a communication unit 22.

The obtaining unit 21 obtains information (object information) indicating the plural components (hereinafter, in some cases, simply referred to as “plural components”) included in the energy storage system 30 to be verified. The communication unit 22 transmits the object information obtained by the obtaining unit 21 to the determination apparatus 10.

The energy storage system 30 to be verified refers to the energy storage system 30 which is an object of a process for verifying whether or not the configuration is regular. Note that, as described above, in a case where the surveillance apparatus 20 and the energy storage system 30 are one-to-one, the obtaining unit 21 obtains the object information from the corresponding energy storage system 30.

For example, the obtaining unit 21 receives each of the component IDs from each of the plural components included in the energy storage system 30 to be verified. The communication unit 22 transmits the object information including the component ID to the determination apparatus 10.

As another example, the obtaining unit 21 may receive each of the component IDs indicating each of the identification numbers from each of the plural components. Then, the obtaining unit 21 may calculate a transmission value by arithmetic based on the identification number. The arithmetic is exemplified by, for example, adding plural identification numbers or obtaining an average value of the plural identification numbers, but the arithmetic is not limited thereto. The communication unit 22 may transmit the object information including the transmission value to the determination apparatus 10.

The obtaining unit 21 may transmit a request for the component ID to each of the plural components and receive the component ID returned in response to the request. In addition, the obtaining unit 21 may receive the component ID transmitted by each of the plural components according to the instruction of the component which controls the overall energy storage system 30.

In the former example, the obtaining unit 21 may include a unit for detecting that a predetermined timing reaches and a unit for transmitting a request for the component ID to each of the plural components according to the detection. In addition, as described in the following example embodiment, the determination apparatus 10 may include a unit for detecting that the timing mentioned above reaches and a unit for transmitting the request for the component ID to the determination apparatus 10 according to the detection. The obtaining unit 21 may transmit the request for the component ID to each of the plural components according to the request for the object information from the determination apparatus 10.

An example of the predetermined timing includes “timing when the energy storage system 30 is powered ON”, “timing when the energy storage system 30 accepts an instruction input for operating the energy storage system 30 in a state in which operation permission is not received from the determination apparatus 10”, “timing when the energy storage system 30 accepts an instruction input for operating the energy storage system 30 regardless of whether or not the operation permission is received”, “timing when a predetermined date and time (for example, 0 o'clock on 1st every month) arrives in a state where the operation permission is received from the determination apparatus 10”, “timing when the operation permission is applied (timing when the energy storage system 30 accepts an application input of the operation permission, timing when the surveillance apparatus 20 receives the application input from the corresponding energy storage system 30, and timing when the determination apparatus 10 receives the application from the surveillance apparatus 20)”, or the like, but the example is not limited thereto. Note that, the obtaining unit 21 or the determination apparatus 10 can receive information (information or the like indicating input contents made by operating the energy storage system 30) for detecting the timing from the energy storage system 30 and detect the timing on the basis of the information.

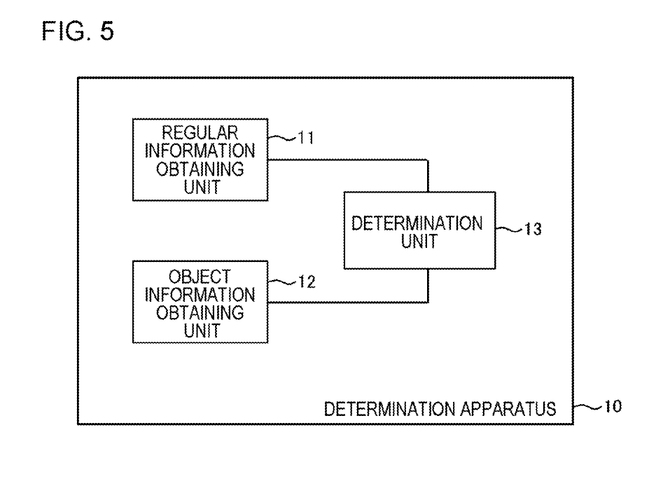

Next, the determination apparatus 10 will be described. FIG. 5 illustrates an example of a functional block diagram of the determination apparatus 10. As illustrated, the determination apparatus 10 includes a regular information obtaining unit (information obtaining unit) 11, an object information obtaining unit 12, and a determination unit 13.

The regular information obtaining unit 11 obtains regular information (first information) indicating the plural components, included in the energy storage system 30, associated with each of the energy storage systems 30. The regular information obtaining unit 11 can obtain (1) “the plural components (each of the system controllers 31 may include information defining the component of a device other than the system controller 31) determined for each of the energy storage systems 30” stored in advance in a database or the like, (2) “information in which the plural components (devices) satisfying a safety standard are defined for each of products of the energy storage system 30 by an manufacturer (system integrator)” stored in advance in the database or the like, (3) “information on device configurations tested and listed as satisfying the safety standard at a certification authority or the like or information on device configurations verified and authenticated as conforming to an international safety standard” stored in advance in the database or the like, and (4) “configuration information of other device parts for using device component parts verified to satisfy the international safety standard or another safety standard at the certification authority or the like or device configuration information which can verify that a combination with the other device parts matches a list at the time of authentication” stored in advance in the database or the like.

For example, the regular information obtaining unit 11 may obtain the regular information corresponding to the energy storage system 30 to be verified from a regular information storage unit (first information storage unit) which stores the regular information corresponding to each of the plural energy storage systems 30.

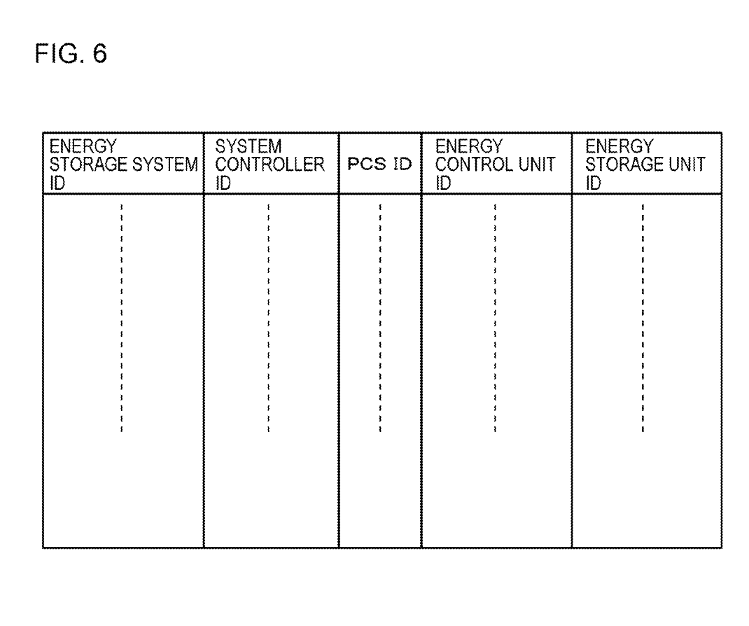

FIG. 6 is a diagram schematically illustrating an example of information stored in the regular information storage unit. As illustrated, information for identifying the energy storage system 30 is associated with information (component ID) for identifying each of the plural components included in the regular energy storage system 30. Note that, in a case where there are plural combinations of the regular components corresponding to one energy storage system 30 (for example, case where there are plural usable ones in one unit (for example, energy storage unit)), the plural combinations corresponding to one energy storage system 30 may be registered in the regular information storage unit. In addition, the latest version of software installed in each of the components may be registered in the regular information storage unit.

The determination apparatus 10 may include the regular information storage unit and another external apparatus configured to be capable of communicating with the determination apparatus 10 may include the regular information storage unit.

For example, the regular information obtaining unit 11 may obtain information (for example, model number or the like) for identifying the energy storage system 30 to be verified from the surveillance apparatus 20 which surveils the energy storage system 30 to be verified (the energy storage system 30 to be verified for a configuration). For example, in advance, the information for identifying the energy storage system 30 to be surveilled may be registered in a storage device in the surveillance apparatus 20. The surveillance apparatus 20 may transmit the information to the regular information obtaining unit 11. In addition, the surveillance apparatus 20 may obtain the information for identifying the energy storage system 30 from the energy storage system 30 to be surveilled and may transmit the information to the regular information obtaining unit 11.

When obtaining the information of identifying the energy storage system 30 to be verified, the regular information obtaining unit 11 may obtain the regular information corresponding to the energy storage system 30 to be verified from the regular information storage unit (not shown in the drawings).

As another example of the process of the regular information obtaining unit 11 obtaining the regular information, the regular information obtaining unit 11 may obtain the regular information corresponding to a client from the regular information storage unit (not shown in the drawings) which stores the regular information corresponding to each of plural clients.

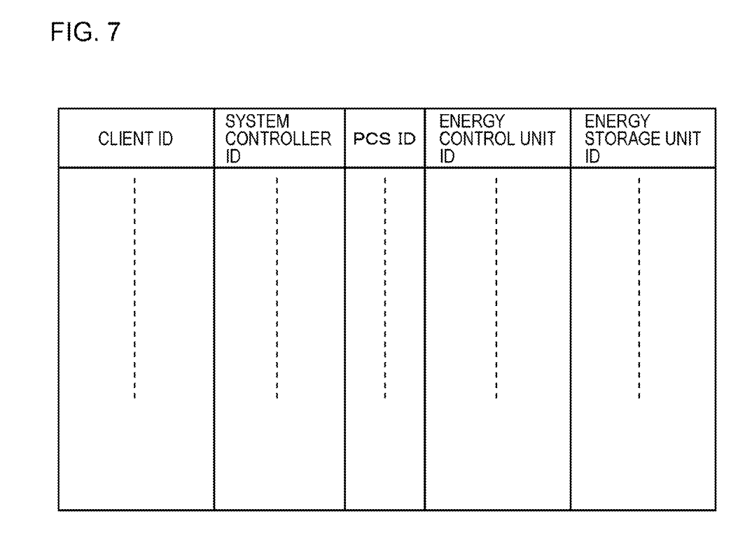

FIG. 7 is a diagram schematically illustrating an example of information stored in the regular information storage unit. As illustrated, information for identifying the client is associated with information (component ID) for identifying each of the plural components included in the regular energy storage system 30 related to the client. Note that, in a case where there are the plural combinations of the regular components corresponding to one client (for example, case where there are the plural usable ones in one unit (for example, energy storage unit)), the plural combinations corresponding to one client may be registered in the regular information storage unit. In addition, the latest version of software installed in each of the components may be registered in the regular information storage unit.

The determination apparatus 10 may include the regular information storage unit and another external apparatus configured to be capable of communicating with the determination apparatus 10 may include the regular information storage unit.

For example, the regular information obtaining unit 11 may obtain the information for identifying the client related to the energy storage system 30 to be verified from the surveillance apparatus 20 which surveils the energy storage system 30 to be verified. For example, in advance, the information for identifying the client may be registered in the storage device in the surveillance apparatus 20. The surveillance apparatus 20 may transmit the information to the regular information obtaining unit 11. In addition, the surveillance apparatus 20 may obtain the information for identifying the client from the energy storage system 30 to be surveilled and may transmit the information to the regular information obtaining unit 11.

When obtaining the information of identifying the client related to the energy storage system 30 to be verified, the regular information obtaining unit 11 may obtain the regular information corresponding to the client from the regular information storage unit (not shown in the drawings) which stores the regular information corresponding to each of the plural clients.

As another example of the process of the regular information obtaining unit 11 obtaining the regular information, the energy storage system 30 may stores the own regular information. Alternatively, the surveillance apparatus 20 may store the regular information of the corresponding energy storage system 30. The regular information obtaining unit 11 may obtain the regular information stored by the surveillance apparatus 20 and/or the energy storage system 30.

Returning to FIG. 5, the object information obtaining unit 12 obtains the object information indicating the plural components included in the energy storage system 30 to be verified. The object information obtaining unit 12 receives the object information transmitted by the communication unit 22 of the surveillance apparatus 20.

The determination unit 13 determines whether or not the configuration of the energy storage system 30 to be verified is regular on the basis of the regular information obtained by the regular information obtaining unit 11 and the object information obtained by the object information obtaining unit 12.

For example, the determination unit 13 determines whether or not a combination of the plural components indicated by the regular information coincides with a combination of the plural components indicated by the object information. In a case where the combinations coincide with each other, the determination unit 13 determines that “the energy storage system 30 to be verified has a regular configuration”. On the other hand, in a case where the combinations do not coincide with each other, the determination unit 13 determines that “the energy storage system 30 to be verified has a non-regular configuration”.

Note that, as described above, the component ID obtained by the object information obtaining unit 12 may include a version of installed software. The regular information (component ID of genuine product) obtained by the regular information obtaining unit 11 may include the latest version of software installed in each of the components. In this case, in a case where at least one of the components does not have the installed software with the latest version (that is, case where the version of the software indicated by the component ID obtained by the object information obtaining unit 12 does not coincide with the version of the software indicated by the regular information), the determination unit 13 determines that “the energy storage system 30 to be verified has a non-regular configuration”. On the other hand, in a case where all of the components have the installed software with the latest version (that is, case where the version of the software indicated by the component ID obtained by the object information obtaining unit 12 coincides with the version of the software indicated by the regular information) and other information included in the component ID obtained by the object information obtaining unit 12 coincides with other information included in the regular information, the determination unit 13 determines that “the energy storage system 30 to be verified has a regular configuration”.

In addition, in a case where the object information received by the object information obtaining unit 12 is a transmission value calculated by arithmetic based on the identification number obtained from each of the plural components included in the energy storage system 30 to be verified, the determination unit 13 determines that a regular value calculate by the same arithmetic based on the identification number corresponding to each of the plural components indicated by the regular information coincides with the transmission value. In a case where the values coincide with each other, the determination unit 13 determines that “the energy storage system 30 to be verified has a regular configuration”. On the other hand, in a case where the values do not coincide with each other, the determination unit 13 determines that “the energy storage system 30 to be verified has a non-regular configuration”.

Note that, the determination unit 13 may determine whether or not to permit the operation of the energy storage system 30 on the basis of the determination result (whether or not the configuration is regular). In the case of the regular configuration, the determination unit 13 permits the operation and in the case of the non-regular configuration, the determination unit 13 does not permit the operation.

The determination apparatus 10 may transmit the determination result of the determination unit 13 to the surveillance apparatus 20 and the energy storage system 30. In this case, in a case of receiving permission to operate from the determination apparatus 10, the energy storage system 30 can operate and in a case of not receiving the permission to operate, the energy storage system 30 cannot operate. For example, the component (for example, the system controller 31 in FIG. 3) which controls the overall energy storage system 30 controls the operation of the energy storage system 30 on the basis of contents (whether or not to permit the operation) notified from the determination apparatus 10.

In addition, if it is determined that the energy storage system to be verified has the non-regular configuration, the determination apparatus 10 may output a warning. For example, the determination apparatus 10 may output the warning to an operator of the determination apparatus 10 through the display or the speaker.

In addition, the determination apparatus 10 may transmit the warning to the surveillance apparatus 20. The surveillance apparatus 20 may output the warning to a user according to the reception of the warning. The warning to the user is exemplified by lighting a warning lamp, outputting information on the warning through the display or the speaker, and the like, but the warning is not limited thereto.

In addition, the surveillance apparatus 20 may transmit the warning received from the determination apparatus 10 to the energy storage system 30. The energy storage system 30 may output the warning to the user according to the reception of the warning. The warning to the user is exemplified by lighting a warning lamp, outputting information on the warning through the display or the speaker, and the like, but the warning is not limited thereto.

In addition, the determination apparatus 10 may register a warning transmission destination (for example, e-mail address) associated with each of the plural energy storage systems 30. The determination apparatus 10 may transmit the warning to the warning transmission destination corresponding to the energy storage system 30 determined to have the non-regular configuration.

In addition, if it is determined that the energy storage system to be verified has the non-regular configuration, the determination apparatus 10 may output an instruction of stopping the operation of the energy storage system 30. The instruction is transmitted to the surveillance apparatus 20 corresponding to the energy storage system 30 determined to have the non-regular configuration. The surveillance apparatus 20 transmits the instruction to the corresponding energy storage system 30. The energy storage system 30 stops the operation according to the instruction.

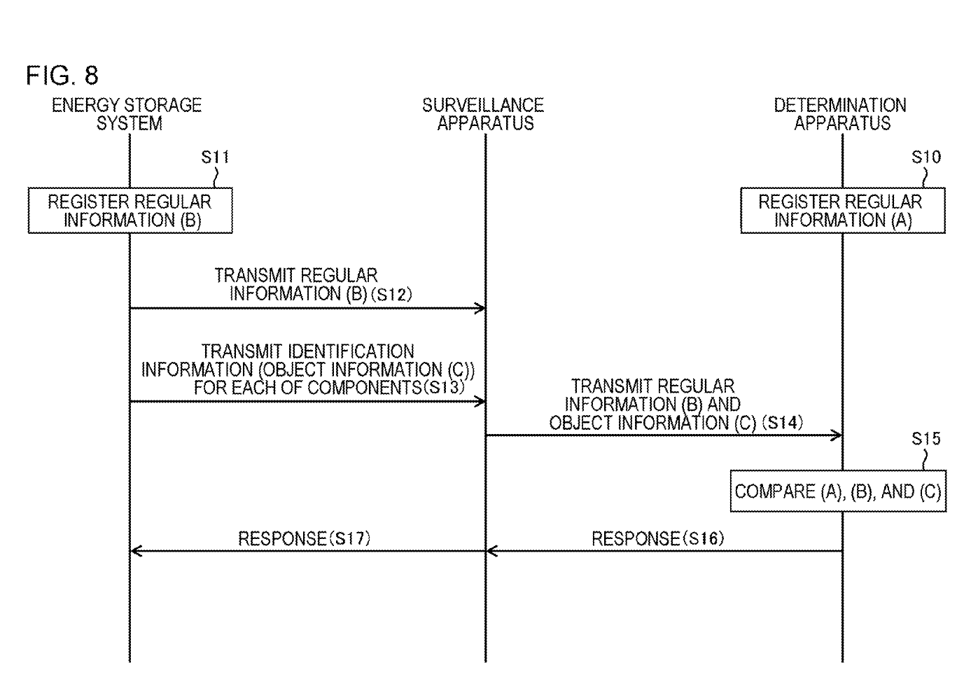

Next, an example of a flow of a process of the surveillance system according to the present example embodiment will be described with reference to a sequence diagram in FIG. 8.

[Process Example in Case where Operation is not Permitted]

As preparation, the determination apparatus 10 registers the regular information indicating the plural components included in the regular energy storage system 30 in the regular information storage unit (S10). Thus, for example, the information illustrated in FIG. 6 and FIG. 7 is registered in the regular information storage unit. In addition, each of the plural energy storage systems 30 registers the regular information indicating the plural components included in the own regular system in the own system (S11). For example, the operator operates the determination apparatus 10 or the energy storage system 30, so that the registration may be performed.

At a predetermined timing after this, the energy storage system 30 transmits the regular information registered in the own system to the surveillance apparatus 20 (S12). The energy storage system 30 transmits the regular information to the surveillance apparatus 20, for example, at a “timing when the energy storage system 30 is powered ON”, “timing when an instruction input for operating the energy storage system 30 is accepted”, “timing when the operation permission is applied (timing when the energy storage system 30 accepts an application input of the operation permission, timing when the surveillance apparatus 20 receives the application input from the corresponding energy storage system 30, and timing when the determination apparatus 10 receives the application from the surveillance apparatus 20)”, or the like. The energy storage system 30 may detect the timing, the surveillance apparatus 20 may detect the timing, or the determination apparatus 10 may detect the timing.

In addition, at the predetermined timing, each of the plural components constituting the energy storage system 30 transmits the component ID (the object information) indicating the own unit to the surveillance apparatus 20 (S13). Each of the plural components transmits the component ID to the surveillance apparatus 20, for example, at a “timing when the energy storage system 30 is powered ON”, “timing when an instruction input for operating the energy storage system 30 is accepted”, “timing when the operation permission is applied (timing when the energy storage system 30 accepts an application input of the operation permission, timing when the surveillance apparatus 20 receives the application input from the corresponding energy storage system 30, and timing when the determination apparatus 10 receives the application from the surveillance apparatus 20)”, or the like. The energy storage system 30 may detect the timing, the surveillance apparatus 20 may detect the timing, or the determination apparatus 10 may detect the timing. Note that, orders of S12 and S13 are not limited to those illustrated.

After then, the surveillance apparatus 20 transmits the regular information and the object information received from the energy storage system 30 to the determination apparatus 10 (S14). The surveillance apparatus 20 may transmit these pieces of information to the determination apparatus 10 at one time or may separately transmit these pieces of information. For example, in a case of transmitting the object information of the energy storage system 30 illustrated in FIG. 3, firstly, the object information including the component ID of the system controller 31 may be transmitted, after then, the object information including the component ID of other component may be transmitted.

Further, in addition to the regular information and the object information, the surveillance apparatus 20 may obtain the information for identifying the energy storage system 30 to be surveilled or the information for identifying the client related to the energy storage system 30 and may transmit the information to the determination apparatus 10. The surveillance apparatus 20 may receive the information from the energy storage system 30 or may store the information in the own apparatus in advance. In a case where the operation permission is not received, these pieces of information are transmitted to the determination apparatus 10 together with the application of the operation permission.

The determination apparatus 10 searches (see FIG. 6 and FIG. 7) the regular information storage unit with the information for identifying the energy storage system 30 to be surveilled or the information for identifying the client related to the energy storage system 30 as a key and obtains the regular information corresponding to the key. The determination apparatus 10 compares the regular information obtained from the regular information storage unit, the regular information received from the surveillance apparatus 20, and the object information received from the surveillance apparatus 20 with one another (S15).

According to a result of the comparison in S15, in a case where all pieces of information coincide with one another, the determination apparatus 10 determines that the energy storage system 30 has the regular configuration. Then, the determination apparatus 10 responds to the surveillance apparatus 20 that the operation is permitted (S16).

On the other hand, according to the result of the comparison in S15, in a case where at least one pieces of information does not coincide with the others, the determination apparatus 10 determines that the energy storage system 30 has the non-regular configuration. Then, the determination apparatus 10 responds to the surveillance apparatus 20 that the operation is not permitted (S16).

The surveillance apparatus 20 notifies the energy storage system 30 of the response received from the determination apparatus 10 (S17). The energy storage system 30 controls the own system on the basis of the notified contents. That is, in a case where the response that the operation is permitted is received, the energy storage system 30 enters into an operable state. On the other hand, in a case where the response that the operation is not permitted is received, the energy storage system 30 enters into an inoperable state. In this case, the energy storage system 30 may notify the user that the operation is not permitted. A notification unit is implemented by using the output devise such as the display, the speaker, the mailer, the printer, and the like.

[Process Example in Case where Operation is Permitted]

In a case where the operation is permitted, S12 to S17 of FIG. 8 are repeated. That is, the surveillance apparatus 20 receives the regular information and the object information from the energy storage system 30 at a predetermined timing (S12 and S13). For example, the predetermined timing is exemplified as “timing when a predetermined date and time (for example, 0 o'clock on 1st every month) arrives”, “timing when the energy storage system 30 is powered ON”, “timing when the operation permission is applied (timing when the energy storage system 30 accepts an application input of the operation permission, timing when the surveillance apparatus 20 receives the application input from the corresponding energy storage system 30, and timing when the determination apparatus 10 receives the application from the surveillance apparatus 20)”, and the like, but the predetermined timing is not limited thereto. The energy storage system 30 may detect the timing, the surveillance apparatus 20 may detect the timing, or the determination apparatus 10 may detect the timing.

Thereafter, the same process as described in “the process example in the case where the operation is not permitted” is repeated. Note that, in the case where the response that the operation is permitted is received (S17), the energy storage system 30 continues to operate as it is. On the other hand, in the case where the response that the operation is not permitted is received (S17), the energy storage system 30 stops operating. In this case, the energy storage system 30 may notify the user that the operation is not permitted.

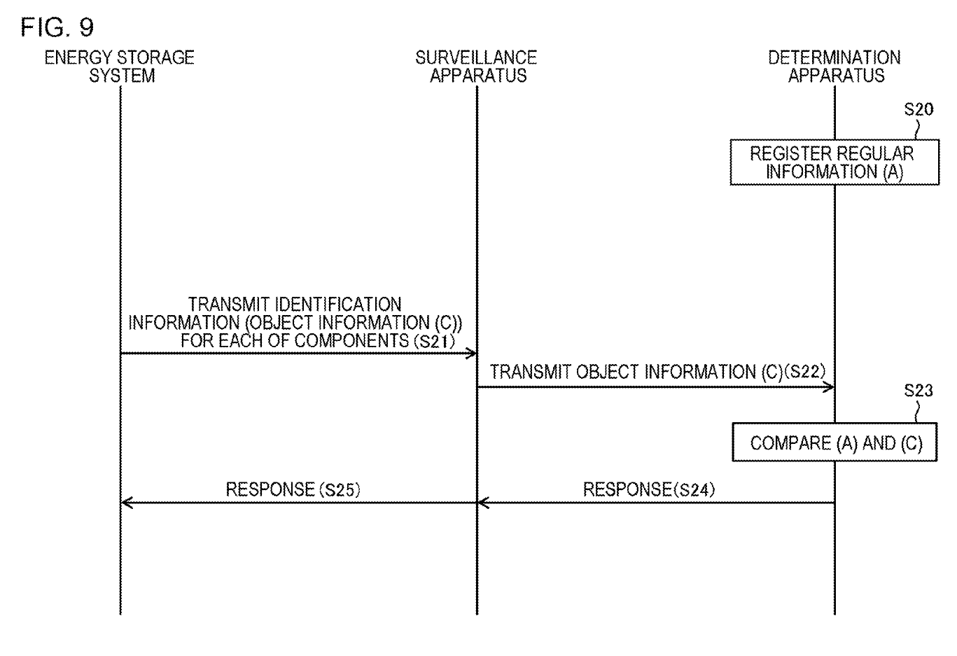

Next, an example of a flow of a process of the surveillance system according to the present example embodiment will be described with reference to a sequence diagram in FIG. 9.

[Process Example in Case where Operation is not Permitted]

As preparation, the determination apparatus 10 registers the regular information indicating the plural components included in the regular energy storage system 30 in the regular information storage unit (S20). Thus, for example, the information illustrated in FIG. 6 and FIG. 7 is registered in the regular information storage unit. For example, the operator operates the determination apparatus 10, so that the registration may be performed.

At a predetermined timing after this, each of the plural components constituting the energy storage system 30 transmits the component ID (the object information) indicating the own unit to the surveillance apparatus 20 (S21). Each of the plural components transmits the component ID to the surveillance apparatus 20, for example, at a “timing when the energy storage system 30 is powered ON”, “timing when an instruction input for operating the energy storage system 30 is accepted”, “timing when the operation permission is applied (timing when the energy storage system 30 accepts an application input of the operation permission, timing when the surveillance apparatus 20 receives the application input from the corresponding energy storage system 30, and timing when the determination apparatus 10 receives the application from the surveillance apparatus 20)”, or the like. The energy storage system 30 may detect the timing, the surveillance apparatus 20 may detect the timing, or the determination apparatus 10 may detect the timing.

After then, the surveillance apparatus 20 transmits the object information received from the energy storage system 30 to the determination apparatus 10 (S22). The surveillance apparatus 20 may transmit the object information to the determination apparatus 10 at one time or may separately transmit the object information. For example, in a case of transmitting the object information of the energy storage system 30 illustrated in FIG. 3, firstly, the object information including the component ID of the system controller 31 may be transmitted, after then, the object information including the component ID of other component may be transmitted.

Further, in addition to the object information, the surveillance apparatus 20 may obtain the information for identifying the energy storage system 30 to be surveilled or the information for identifying the client related to the energy storage system 30 and may transmit the information to the determination apparatus 10. The surveillance apparatus 20 may receive the information from the energy storage system 30 or may store the information in the own apparatus in advance. In a case where the operation permission is not received, these pieces of information are transmitted to the determination apparatus 10 together with the application of the operation permission.

The determination apparatus 10 searches (see FIG. 6 and FIG. 7) the regular information storage unit with the information for identifying the energy storage system 30 to be surveilled or the information for identifying the client related to the energy storage system 30 as a key and obtains the regular information corresponding to the key. The determination apparatus 10 compares the regular information obtained from the regular information storage unit and the object information received from the surveillance apparatus 20 with each other (S23).

According to a result of the comparison in S23, in a case where two pieces of information coincide with each other, the determination apparatus 10 determines that the energy storage system 30 has the regular configuration. Then, the determination apparatus 10 responds to the surveillance apparatus 20 that the operation is permitted (S24).

On the other hand, according to the result of the comparison in S23, in a case where two pieces of information do not coincide with each other, the determination apparatus 10 determines that the energy storage system 30 has the non-regular configuration. Then, the determination apparatus 10 responds to the surveillance apparatus 20 that the operation is not permitted (S24).

The surveillance apparatus 20 notifies the energy storage system 30 of the response received from the determination apparatus 10 (S25). The energy storage system 30 controls the own system on the basis of the notified contents. That is, in a case where the response that the operation is permitted is received, the energy storage system 30 enters into the operable state. On the other hand, in a case where the response that the operation is not permitted is received, the energy storage system 30 enters into the inoperable state. In this case, the energy storage system 30 may notify the user that the operation is not permitted. The notification unit is implemented by using the output devise such as the display, the speaker, the mailer, the printer, and the like.

[Process Example in Case where Operation is Permitted]

In the case where the operation is permitted, S21 to S25 of FIG. 9 are repeated. That is, the surveillance apparatus 20 receives the object information from the energy storage system 30 at a predetermined timing (S21). For example, the predetermined timing is exemplified as “timing when a predetermined date and time (for example, 0 o'clock on 1st every month) arrives”, “timing when the energy storage system 30 is powered ON”, “timing when the operation permission is applied (timing when the energy storage system 30 accepts an application input of the operation permission, timing when the surveillance apparatus 20 receives the application input from the corresponding energy storage system 30, and timing when the determination apparatus 10 receives the application from the surveillance apparatus 20)”, and the like, but the predetermined timing is not limited thereto. The energy storage system 30 may detect the timing, the surveillance apparatus 20 may detect the timing, or the determination apparatus 10 may detect the timing.

Thereafter, the same process as described in “the process example in the case where the operation is not permitted” is repeated. Note that, in the case where the response that the operation is permitted is received (S25), the energy storage system 30 continues to operate as it is. On the other hand, in the case where the response that the operation is not permitted is received (S25), the energy storage system 30 stops operating. In this case, the energy storage system 30 may notify the user that the operation is not permitted.

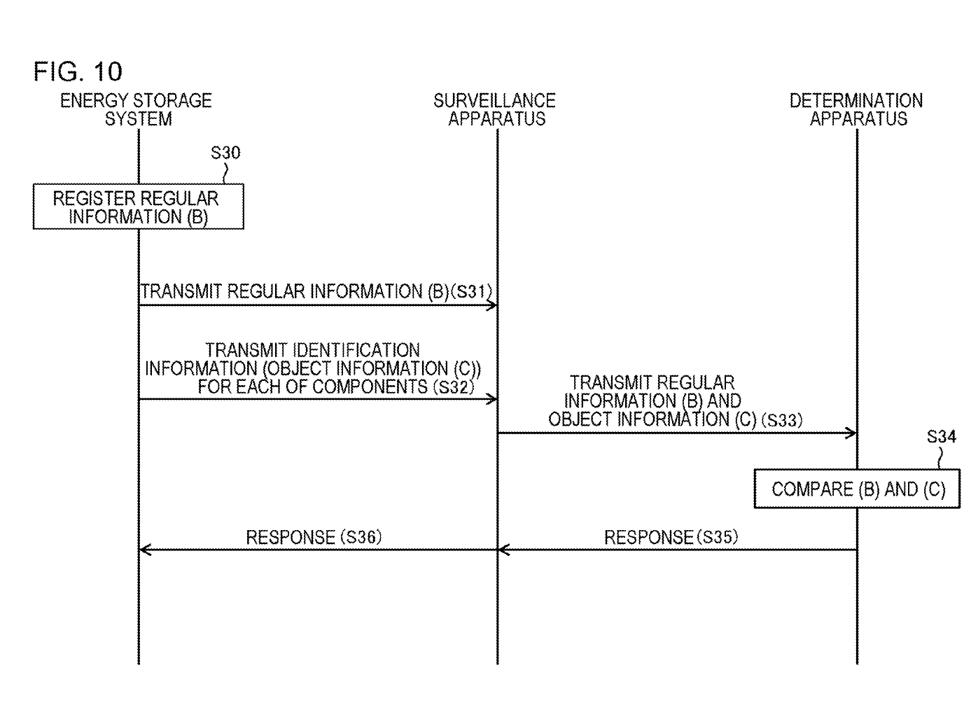

Next, an example of a flow of a process of the surveillance system according to the present example embodiment will be described with reference to a sequence diagram in FIG. 10.

[Process Example in Case where Operation is not Permitted]

As preparation, each of the plural energy storage systems 30 registers the regular information indicating the plural components included in the own regular system in the own system (S30). For example, the operator operates the energy storage system 30, so that the registration may be performed.

At a predetermined timing after this, the energy storage system 30 transmits the regular information registered in the own system to the surveillance apparatus 20 (S31). The energy storage system 30 transmits the regular information to the surveillance apparatus 20, for example, at a “timing when the energy storage system 30 is powered ON”, “timing when an instruction input for operating the energy storage system 30 is accepted”, “timing when the operation permission is applied (timing when the energy storage system 30 accepts an application input of the operation permission, timing when the surveillance apparatus 20 receives the application input from the corresponding energy storage system 30, and timing when the determination apparatus 10 receives the application from the surveillance apparatus 20)”, or the like. The energy storage system 30 may detect the timing, the surveillance apparatus 20 may detect the timing, or the determination apparatus 10 may detect the timing.

In addition, at the predetermined timing, each of the plural components constituting the energy storage system 30 transmits the component ID (the object information) indicating the own unit to the surveillance apparatus 20 (S32). Each of the plural components transmits the component ID to the surveillance apparatus 20, for example, at a “timing when the energy storage system 30 is powered ON”, “timing when an instruction input for operating the energy storage system 30 is accepted”, “timing when the operation permission is applied (timing when the energy storage system 30 accepts an application input of the operation permission, timing when the surveillance apparatus 20 receives the application input from the corresponding energy storage system 30, and timing when the determination apparatus 10 receives the application from the surveillance apparatus 20)”, or the like. The energy storage system 30 may detect the timing, the surveillance apparatus 20 may detect the timing, or the determination apparatus 10 may detect the timing. Note that, orders of S31 and S32 are not limited to those illustrated.

After then, the surveillance apparatus 20 transmits the regular information and the object information received from the energy storage system 30 to the determination apparatus 10 (S33). The surveillance apparatus 20 may transmit these pieces of information to the determination apparatus 10 at one time or may separately transmit these pieces of information. For example, in a case of transmitting the object information of the energy storage system 30 illustrated in FIG. 3, firstly, the object information including the component ID of the system controller 31 may be transmitted, after then, the object information including the component ID of other component may be transmitted.

Further, in addition to the regular information and the object information, the surveillance apparatus 20 may obtain the information for identifying the energy storage system 30 to be surveilled or the information for identifying the client related to the energy storage system 30 and may transmit the information to the determination apparatus 10. The surveillance apparatus 20 may receive the information from the energy storage system 30 or may store the information in the own apparatus in advance. In a case where the operation permission is not received, these pieces of information are transmitted to the determination apparatus 10 together with the application of the operation permission.

The determination apparatus 10 compares the regular information received from the surveillance apparatus 20 and the object information received from the surveillance apparatus 20 with each other (S34).

According to a result of the comparison in S34, in a case where two pieces of information coincide with each other, the determination apparatus 10 determines that the energy storage system 30 has the regular configuration. Then, the determination apparatus 10 responds to the surveillance apparatus 20 that the operation is permitted (S35).

On the other hand, according to the result of the comparison in S34, in a case where two pieces of information do not coincide with each other, the determination apparatus 10 determines that the energy storage system 30 has the non-regular configuration. Then, the determination apparatus 10 responds to the surveillance apparatus 20 that the operation is not permitted (S35).

The surveillance apparatus 20 notifies the energy storage system 30 of the response received from the determination apparatus 10 (S36). The energy storage system 30 controls the own system on the basis of the notified contents. That is, in a case where the response that the operation is permitted is received, the energy storage system 30 enters into the operable state. On the other hand, in a case where the response that the operation is not permitted is received, the energy storage system 30 enters into the inoperable state. In this case, the energy storage system 30 may notify the user that the operation is not permitted. The notification unit is implemented by using the output devise s such as the display, the speaker, the mailer, the printer, and the like.

[Process Example in Case where Operation is Permitted]

In the case where the operation is permitted, S31 to S36 are repeated. That is, the surveillance apparatus 20 receives the regular information and the object information from the energy storage system 30 at a predetermined timing (S31 and S32). For example, the predetermined timing is exemplified as “timing when a predetermined date and time (for example, 0 o'clock on 1st every month) arrives”, “timing when the energy storage system 30 is powered ON”, “timing when the operation permission is applied (timing when the energy storage system 30 accepts an application input of the operation permission, timing when the surveillance apparatus 20 receives the application input from the corresponding energy storage system 30, and timing when the determination apparatus 10 receives the application from the surveillance apparatus 20)”, and the like, but the predetermined timing is not limited thereto. The energy storage system 30 may detect the timing, the surveillance apparatus 20 may detect the timing, or the determination apparatus 10 may detect the timing.

Thereafter, the same process as described in “the process example in the case where the operation is not permitted” is repeated. Note that, in the case where the response that the operation is permitted is received (S36), the energy storage system 30 continues to operate as it is. On the other hand, in the case where the response that the operation is not permitted is received (S36), the energy storage system 30 stops operating. In this case, the energy storage system 30 may notify the user that the operation is not permitted.

Next, a modification of the present example embodiment be described.

In the present example embodiment, the example in which the determination apparatus 10 includes “a unit (the determination unit 13) which determines whether or not the configuration of the energy storage system 30 to be verified is regular on the basis of the regular information and the object information” is described, but the surveillance apparatus 20 may include the unit.

In the case of the process example illustrated in FIG. 8, the surveillance apparatus 20 obtains the regular information (A) from the determination apparatus 10, obtains the regular information (B) and the object information (C) from the energy storage system 30, and compares the regular information (A), the regular information (B), and the object information (C) with one another. In the case of the process example illustrated in FIG. 9, the surveillance apparatus 20 obtains the regular information (A) from the determination apparatus 10, obtains the object information (C) from the energy storage system 30, and compares the regular information (A) and the object information (C) with each other. In the case of the process example illustrated in FIG. 10, the surveillance apparatus 20 obtains the regular information (B) and the object information (C) from the energy storage system 30 and compares the regular information (B) and the object information (C) with each other.

In a case of the modification, the surveillance apparatus 20 notifies the determination apparatus 10 of the determination result. The determination apparatus 10 manages a state (configuration and operation permission state) of the energy storage system 30 on the basis of the notified contents. The determination apparatus 10 may determine whether or not to permit the operation or the surveillance apparatus 20 may determine whether or not to permit the operation.

In the present example embodiment, the example in which all of the plural components included in the energy storage system 30 include the unit which stores the component ID and the unit which transmits the component ID to the surveillance apparatus 20 is described, but some components may not include these units, as another modification. Hereinafter, the component not including these units will be referred to as “non-corresponding component”.

In a case of the modification, another component obtains the information for identifying the non-corresponding component and transmits the information to the surveillance apparatus 20. For example, the non-corresponding component is the energy storage unit 34 illustrated in FIG. 3. Then, for example, the PCS 32 obtains the information for identifying the energy storage unit 34 and transmits the information to the surveillance apparatus 20. For example, the PCS 32 causes the energy storage system 30 to perform a charge and discharge operation with a predetermined test pattern (for example, a pattern of current [A] or output/input electric power [kW]). The energy storage system 30 obtains measured data (for example, voltage or charge and discharge characteristics (for example, charge and discharge curve)) at the time of the charge and discharge operation and transmits the measured data to the surveillance apparatus 20 as information for identifying the energy storage unit 34.

Three patterns of the measured data are considered. The first is a pattern in which a total voltage (voltage of cell stack) is measured. The second is a pattern in which a voltage (voltage of each of the blocks) for each of plural blocks included in the cell stack is measured. The third is a pattern in which a voltage (voltage of each of the cells) for each of plural cells included in each of the blocks is measured. Although it is possible to identify the energy storage unit 34 in any case, it is possible to more accurately determine the measured data as the voltage for each of the cells.

In a case where a monitor substrate such as a cell monitor or the like is provided in the energy storage unit 34, the energy storage unit can measure the cell voltage. In this case, the surveillance apparatus 20 may directly obtain the measured data from the energy storage unit 34 and may obtain the measured data through the energy control unit 33.

In a case where the cell monitor is not provided in the energy storage unit 34, the energy control unit 33 may measure the cell voltage. The surveillance apparatus 20 may obtain the measured data from the energy control unit 33.

In addition, the PCS 32 may measure the total voltage (voltage of cell stack). The surveillance apparatus 20 may obtain the measured data from the PCS 32.

Note that, in a case where the energy storage unit 34 is divided into the plural blocks, the voltage of each of the blocks can be measured by the energy control unit 33 or the monitor substrate for each of the modules. The surveillance apparatus 20 can obtain the measured data from the energy storage unit 34 or the energy control unit 33.

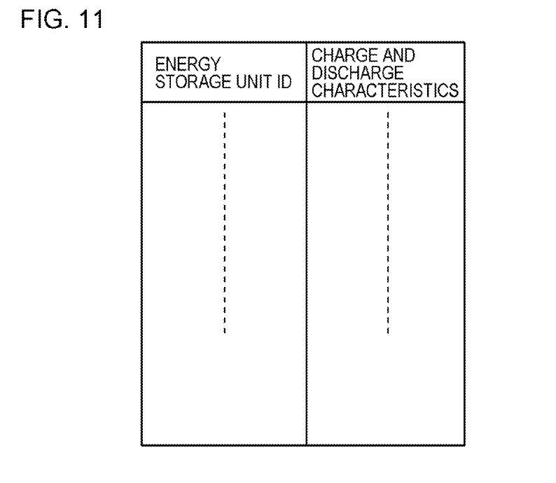

When the obtaining unit 21 of the surveillance apparatus 20 receives the measured data (information indicating charge and discharge characteristics), the obtaining unit 21 transmits the object information including the measured data (information indicating charge and discharge characteristics) to the determination apparatus 10. For example, the PCS 32 transmits the measured data of the energy storage unit 34 to the surveillance apparatus 20 and the surveillance apparatus 20 receives the measured data of the energy storage unit 34 through the PCS 32. The determination apparatus 10 identifies the energy storage unit 34 on the basis of the received measurement data (information indicating charge and discharge characteristics). For example, the determination apparatus 10 stores information indicating charge and discharge characteristics in advance associated with each of plural the energy storage units 34 (see FIG. 11). The determination apparatus 10 identifies the energy storage unit 34 on the basis of the information and the received measurement data (information indicating charge and discharge characteristics).

As another modification, as described above, the surveillance apparatus 20 can separately transmit the component ID (the object information) of each of the plural components to the determination apparatus 10 (S14 in FIG. 8, S22 in FIG. 9, and S33 in FIG. 10).

When the object information including the component IDs of the system controller 31, the PCS 32, the energy control unit 33, and the energy storage unit 34 is transmitted to the determination apparatus 10, it is necessary for the determination apparatus 10 to compare the object information including plural component IDs with the corresponding regular information. However, in a case where the object information, the identification information, and the like are not transmitted together, since it is necessary to extract and compare the corresponding regular information from among a lot of pieces of regular information stored in the regular information storage unit, it may take time to examine whether or not the object information is regular.

Therefore, the component ID related to the system controller 31 may first be transmitted to the determination apparatus 10. The determination apparatus 10 may extract the regular information including the plural component IDs other than the system controller 31 corresponding to the system controller 31 by using the received component ID of the system controller 31. In addition, if an ACK is transmitted from the determination apparatus 10 to the energy storage system 30 through the surveillance apparatus 20, the object information including the component IDs of the components (the PCS 32, the energy control unit 33, the energy storage unit 34, and the like) other than the system controller 31 may be transmitted to the determination apparatus 10.

The determination apparatus 10 can easily determine whether or not the object information is regular by comparing the extracted regular information (other than the system controller 31) with the object information. In a case of the modification, the component ID of the system controller 31 may be used instead of “the information for identifying the energy storage system 30” described above. Note that, in the modification, the regular information storage unit stores the component IDs of the plural components (the PCS 32, the energy control unit 33, the energy storage unit 34, and the like) other than the system controller 31, linked with the component ID of the system controller 31.

Next, an advantageous effect of the present example embodiment will be described.

The determination apparatus 10 of the present example embodiment can determine whether or not the configuration of the energy storage system 30 to be verified is regular on the basis of the regular information indicating the plural components included in the regular energy storage system 30 and the object information indicating the plural components included in the energy storage system 30 to be verified. According to the surveillance system of the present example embodiment, it is possible to detect that the combination of the plural components of the energy storage system 30 is out of the regular state on the basis of the determination result of the determination apparatus 10.

In addition, according to the surveillance system of the present example embodiment, it is possible to control the operation of the energy storage system 30 on the basis of the determination result of the determination apparatus 10. It is possible to stop the operation of the energy storage system 30 of which the combination of the plural components is out of the regular state and it is possible to operate only the energy storage system 30 of which the combination of the plural components is in the regular state. For this reason, it is possible to suppress an unexpected situation (for example, accident) from occurring due to the operation of the energy storage system 30 of which the combination of the plural components is out of the regular state.

In addition, according to the surveillance system of the present example embodiment, it is possible to obtain the component ID from each of the plural components included in the energy storage system 30 to be verified and it is possible to use the component ID as the object information. For this reason, in a case where an imitation unit which does not have the unit which stores the component ID, the unit which reads the stored component ID and transmits the component ID to the surveillance apparatus 20, and the like is incorporated in the energy storage system 30, it is possible to efficiently detect the imitation unit.

In addition, in the case of the surveillance system of the present example embodiment, it is possible to determine whether or not the configuration of the energy storage system 30 is regular at a predetermined timing (“timing when the energy storage system 30 is powered ON”, “timing when an instruction input for operating the energy storage system 30 is accepted”, “timing when the operation permission is applied (timing when the energy storage system 30 accepts an application input of the operation permission, timing when the surveillance apparatus 20 receives the application input from the corresponding energy storage system 30, and timing when the determination apparatus 10 receives the application from the surveillance apparatus 20)”, or the like) before the start of the operation. For this reason, it is possible to suppress in advance inconvenience in which the energy storage system 30 which has the non-regular configuration is operated.

In addition, in the case of the surveillance system of the present example embodiment, even after issuing the operation permission, it is possible to regularly and repeatedly determine whether or not the configuration of the energy storage system 30 is regular. For this reason, it is possible to suppress inconvenience in which some of the components are changed after issuing the operation permission.

In addition, in the case of the surveillance system of the present example embodiment, it is possible to determine whether or not the configuration of the energy storage system 30 is regular at a timing when the energy storage system 30 is powered ON. Normally, remodeling of the energy storage system 30 is considered to be performed with the power supply turned OFF. By determining whether or not the configuration of the energy storage system 30 is regular at the timing when the energy storage system 30 is powered ON, it is possible to detect the energy storage system 30 which has the non-regular configuration at a more early stage.

### Second Example Embodiment

In the surveillance system of the present example embodiment, a timing when the determination apparatus 10 requests the object information is detected. The surveillance apparatus 20 and the energy storage system 30 have the same configuration as the first example embodiment.

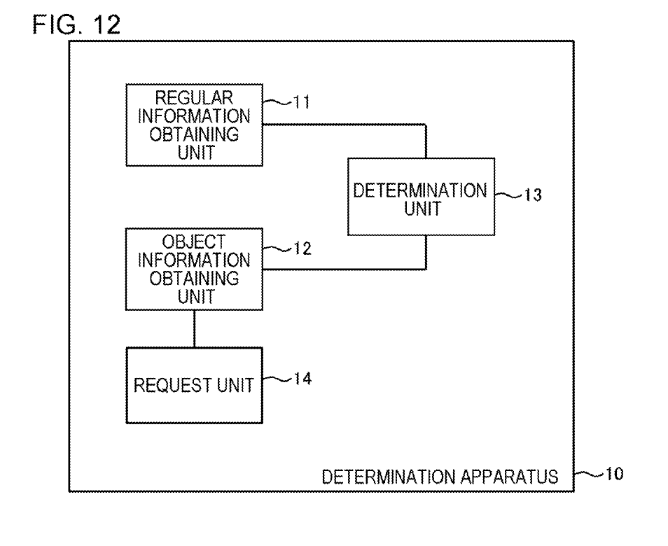

FIG. 12 is an example of a functional block diagram illustrating the determination apparatus 10 of the present example embodiment. As illustrated, the determination apparatus 10 includes the regular information obtaining unit 11, the object information obtaining unit 12, the determination unit 13, and a request unit 14. The regular information obtaining unit 11, the object information obtaining unit 12, and the determination unit 13 have the same configuration as the first example embodiment.

The request unit 14 requests the object information from the surveillance apparatus 20 at a predetermined timing.

For example, the request unit 14 may determine the timing of requesting the object information on the basis of state data indicating a state of the energy storage system 30.

The state data includes at least one of an integrated charge electric power amount [Wh] within a most recent predetermined period (for example, 1 hour, 1 day, 1 week, 10 days, or the like), an integrated discharge electric power amount [Wh] within the most recent predetermined period, a statistical value (for example, average value, maximum value, minimum value, mode value, median value, or the like) of a temperature of the energy storage system 30 within the most recent predetermined period, and a statistical value (for example, average value, maximum value, minimum value, mode value, median value, or the like) of a battery voltage of the energy storage system 30 within the most recent predetermined period. The request unit 14 can obtain the state data from the surveillance apparatus 20 or the energy storage system 30.

In a case where a value of the state data diverges from a reference value by a predetermined level or more, the request unit 14 can request the object information. The reference value may be a statistical value (for example, average value, maximum value, minimum value, mode value, median value, or the like) of the state data of the energy storage system 30 for a predetermined period of time in the past or may be a predetermined value.

As another example, in a case where the operation permission is applied from the energy storage system 30, the request unit 14 may request the object information from the surveillance apparatus 20 which surveils the energy storage system 30.

As another example, the request unit 14 may request the object information from the surveillance apparatus 20 which surveils the energy storage system 30 according to installation of the energy storage system 30. For example, by detecting that “the energy storage system 30 accepts an instruction input to operate the energy storage system 30 in a state in which the operation permission is not received from the determination apparatus 10”, the request unit 14 may detect “installation of the energy storage system 30”. In addition, in a case where it is necessary to perform an initial setting by operating the energy storage system 30 when the energy storage system 30 is installed, the installation of the energy storage system 30 may be detected by detecting the operation of performing the initial setting.

As another example, on the basis of a predetermined schedule (for example, 0 o'clock on 1st every month or every week), the request unit 14 may regularly request the object information from the surveillance apparatus 20 which surveils the energy storage system 30.

As another example, the request unit 14 may request the object information from the surveillance apparatus 20 which surveils the energy storage system 30 according to detection of maintenance of the energy storage system 30. The maintenance is exemplified by refresh charge (capacity measurement), maintenance of the device, or the like. The request unit 14 can obtain sensor information sensed by a sensor provided in the energy storage system 30 and detect the maintenance on the basis of the sensor information. For example, the maintenance may be detected by detecting opening or closing of a predetermined opening and closing member of the energy storage system 30 by using a magnetic sensor.

As another example, the request unit 14 may request the object information from the surveillance apparatus 20 which surveils the energy storage system 30 according to detection of replacement of parts of the energy storage system 30. The request unit 14 can obtain sensor information sensed by the sensor provided in the energy storage system 30 and detect the maintenance on the basis of the sensor information. For example, by using the magnetic sensor, it is possible to detect replacement of a part by detecting that a predetermined part is moved away from a predetermined installation position.

As another example, in a case of detecting “timing when the energy storage system 30 is powered ON”, “timing when the energy storage system 30 accepts an instruction input for operating the energy storage system 30 in a state in which operation permission is not received from the determination apparatus 10”, “timing when the energy storage system 30 accepts an instruction input for operating the energy storage system 30 regardless of whether or not the operation permission is received”, “timing when a predetermined date and time (for example, 0 o'clock on 1st every month) arrives in a state where the operation permission is received from the determination apparatus 10”, “timing when the operation permission is applied (timing when the energy storage system 30 accepts an application input of the operation permission, timing when the surveillance apparatus 20 receives the application input from the corresponding energy storage system 30, and timing when the determination apparatus 10 receives the application from the surveillance apparatus 20)”, or the like, the request unit 14 may request the object information from the surveillance apparatus 20 which surveils the energy storage system 30.

Note that, the request unit 14 can receive information (information or the like indicating input contents made by operating the energy storage system 30) for detecting the timing from the energy storage system 30 and detect the timing on the basis of the information.

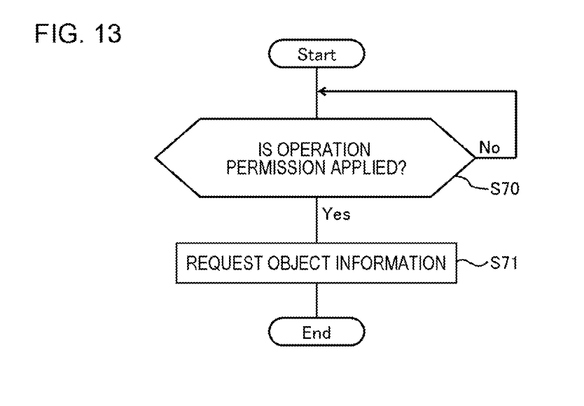

Next, an example of a flow of a process of the request unit 14 according to the present example embodiment will be described with reference to a flowchart in FIG. 13.

The request unit 14 is in a state of waiting for application of the operation permission from the energy storage system 30 (S70). In a case where the operation permission is applied, the request unit 14 requests the object information from the surveillance apparatus 20 which surveils the energy storage system 30 (S71). According to this, some (process in S12 to S17 in FIG. 8, process in S21 to S25 in FIG. 9, or S31 to S36 in FIG. 10) of “the process examples in the case where the operation is not permitted” described in the first example embodiment are performed.

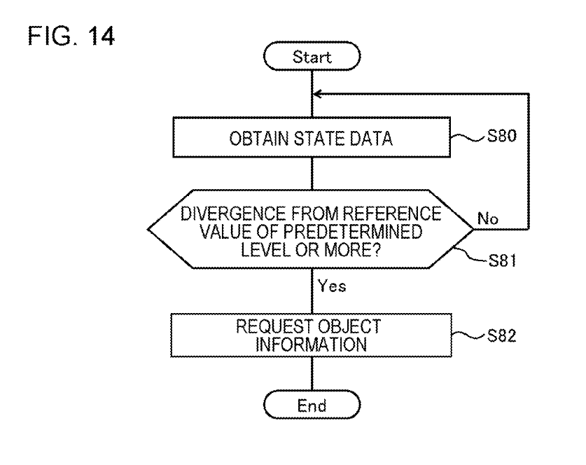

Next, an example of a flow of another process of the request unit 14 according to the present example embodiment will be described with reference to a flowchart in FIG. 14.

The request unit 14 repeatedly receives the state data of the energy storage system 30 having the operation permission from the energy storage system 30 or the surveillance apparatus 20 (S80). The request unit 14 determines whether or not the latest state data deviates by a predetermined level or more from the state data at the normal time (S81).

In a case where the state data does not deviate (No in S81), the process returns to S80 to repeat the same process. On the other hand, in a case where the state data deviates (Yes in S81), the request unit 14 requests the object information from the surveillance apparatus 20 which surveils the energy storage system 30 (S82). According to this, some (process in S12 to S17 in FIG. 8, process in S21 to S25 in FIG. 9, or S31 to S36 in FIG. 10) of “the process examples in the case where the operation is permitted” described in the first example embodiment are performed.

Here, a modification of the present example embodiment be described. The request unit 14 may determine the timing of requesting the object information at the following timing.

### Example 1

In Example 1, various sensors are attached to the surveillance apparatus 20 and/or the energy storage system 30. The request unit 14 obtains the sensor information of various sensors through a predetermined terminal installed on a consumer side. The request unit 14 determines to transmit the request to the surveillance apparatus 20 on the basis of the sensor information. The predetermined terminal may be the surveillance apparatus 20 or the energy storage system 30 or may be other.

Note that, various sensors are configured to include a power supply different from a power supply of the surveillance apparatus 20 or the energy storage system 30 and to continue sensing and transmission of the sensor information even in a case where a power switch of the surveillance apparatus 20 or the energy storage system 30 is turned OFF.

### Example 1-1

In this example, the request unit 14 detects that the energy storage system 30 vibrates by a predetermined level or more on the basis of the sensor information obtained from a vibration sensor. The request unit 14 determines to transmit the request to the surveillance apparatus 20 according to the detection.

In a case of remodeling or the like of the energy storage system 30, it is considered that the energy storage system 30 vibrates by the predetermined level or more. By verifying whether or not the configuration of the energy storage system 30 is regular according to the detection, it is possible to detect remodeling or the like at an early stage.

Note that, during the remodeling, it is assumed that the power switch of the surveillance apparatus 20 or the energy storage system 30 is turned OFF. In this case, the determination apparatus 10 cannot communicate with the surveillance apparatus 20 or the energy storage system 30. In a case of detecting the vibration by the predetermined level or more, the determination apparatus 10 may transmit the request at the timing when it becomes possible to communicate with the surveillance apparatus 20 thereafter.

### Example 1-2

In this example, the request unit 14 detects that the opening and closing member included in the energy storage system 30 is opened on the basis of the sensor information. The request unit 14 determines to transmit the request to the surveillance apparatus 20 according to the detection.

The opening and closing member may be, for example, a member which partitions a space housing the parts of the energy storage system 30 from an external space. In a case of remodeling or the like of the energy storage system 30, it is considered that the opening and closing member is opened. By verifying whether or not the configuration of the energy storage system 30 is regular according to the detection, it is possible to detect remodeling or the like at an early stage.

Note that, during the remodeling, it is assumed that the power switch of the surveillance apparatus 20 or the energy storage system 30 is turned OFF. In this case, the determination apparatus 10 cannot communicate with the surveillance apparatus 20 or the energy storage system 30. In a case of detecting that the opening and closing member is opened, the determination apparatus 10 may transmit the request at the timing when it becomes possible to communicate with the surveillance apparatus 20 thereafter.

Note that, the sensor which detects that the opening and closing member is opened is exemplified by a magnetic sensor and the like, but the sensor is not limited thereto.

### Example 1-3

in this example, the request unit 14 detects that a connection state (for example, connection state of communication line or electric power line) of the plural components (the system controller 31, the PCS 32, the energy control unit 33, the energy storage unit 34, and the like in FIG. 3) included in the energy storage system 30 is released on the basis of the sensor information. The request unit 14 determines to transmit the request to the surveillance apparatus 20 according to the detection.

According to remodeling the energy storage system 30, some of the plural components may be replaced with inexpensive goods. By verifying whether or not the configuration of the energy storage system 30 is regular according to the detection, it is possible to detect remodeling or the like at an early stage.

Note that, during the remodeling, it is assumed that the power switch of the surveillance apparatus 20 or the energy storage system 30 is turned OFF. In this case, the determination apparatus 10 cannot communicate with the surveillance apparatus 20 or the energy storage system 30. In a case of detecting that the connection states of the plural components are released, the determination apparatus 10 may transmit the request at the timing when it becomes possible to communicate with the surveillance apparatus 20 thereafter.

Note that, the sensor which detects that the connection state of the plural components is released is exemplified by a magnetic sensor (for example, which detects that the plural components are at a distance of a predetermined level or more from each other) and the like, but the sensor is not limited thereto.

### Example 1-4

In this example, the request unit 14 detects that the connection state (for example, connection state of communication line) of the energy storage system 30 and the surveillance apparatus 20 is released on the basis of the sensor information. The request unit 14 determines to transmit the request to the surveillance apparatus 20 according to the detection.

In a case of remodeling or the like of the energy storage system 30, it is considered that the connection state with a peripheral device is released. By verifying whether or not the configuration of the energy storage system 30 is regular according to the detection, it is possible to detect remodeling or the like at an early stage.

Note that, during the remodeling, it is assumed that the power switch of the surveillance apparatus 20 or the energy storage system 30 is turned OFF. In this case, the determination apparatus 10 cannot communicate with the surveillance apparatus 20 or the energy storage system 30. In a case of detecting that the connection state of the surveillance apparatus 20 and the energy storage system 30 is released, the determination apparatus 10 may transmit the request at the timing when it becomes possible to communicate with the surveillance apparatus 20 thereafter.

Note that, the sensor which detects that the connection state of the surveillance apparatus 20 and the energy storage system 30 is released is exemplified by a magnetic sensor (for example, which detects that the surveillance apparatus 20 and the energy storage system 30 are at a distance of a predetermined level or more from each other or detects that the surveillance apparatus 20 and/or the energy storage system 30 are at a distance of a predetermined level or more from terminals (terminals of the communication line combining the surveillance apparatus 20 and the energy storage system 30 and the like) of the communication line), but the sensor is not limited thereto.

### Example 2

In Example 2, a camera is attached to the surveillance apparatus 20 and/or the energy storage system 30. The request unit 14 obtains image data captured by the camera through a predetermined terminal installed on a consumer side. The request unit 14 determines to transmit the request to the surveillance apparatus 20 on the basis of the image data. The predetermined terminal may be the surveillance apparatus 20 or the energy storage system 30 or may be other.

For example, the camera may capture a still image at predetermined time intervals (for example, every day, every week, every ten days, every month) or may continuously image a movie. The camera may image an external environment of the energy storage system 30 or may image an inside of the energy storage system 30.

In a case of remodeling the energy storage system 30, it is considered that an image of the external environment imaged by the camera changes by the energy storage system 30 moving to a place different from an installation place or by a direction on the place being changed. In addition, as a result of the remodeling of the energy storage system 30, it is considered that scenery of an internal environment of the energy storage system 30 becomes different (change of part or the like) and the image changes before and after the remodeling. The request unit 14 analyzes the image data to detect a change of a predetermined level or more in the images between two frames. The request unit 14 determines to transmit the request to the surveillance apparatus 20 according to the detection. By verifying whether or not the configuration of the energy storage system 30 is regular according to the detection, it is possible to detect remodeling or the like at an early stage.

Note that, during the remodeling, it is assumed that the power switch of the surveillance apparatus 20 or the energy storage system 30 is turned OFF. In this case, the determination apparatus 10 cannot communicate with the surveillance apparatus 20 or the energy storage system 30. In a case of detecting the change of the predetermined level or more in the image, the determination apparatus 10 may transmit the request at the timing when it becomes possible to communicate with the surveillance apparatus 20 thereafter.

### Example 3

In Example 3, according to the detection of a predetermined date and time (for example, 0 o'clock every day, 0 o'clock on Monday, 0 o'clock on 1st each of months, or the like) being reached, the request unit 14 determines to transmit the request to the surveillance apparatus 20. Note that, the request unit 14 may transmit the request to the surveillance apparatus 20 corresponding to the energy storage system 30 having the operation permission at the timing.

By regularly verifying whether or not the installation position of the energy storage system 30 is regular, it is possible to detect remodeling or the like at an early stage.

### Example 4

In Example 4, the request unit 14 obtains a response time of the energy storage system 30 responding to an instruction from the determination apparatus 10. In a case where the response time changes from a previous value, the request unit 14 determines to transmit the request to the 10. The instruction may be transmitted from the determination apparatus 10 to the energy storage system 30 through the surveillance apparatus 20 and a response data may be transmitted from the energy storage system 30 to the determination apparatus 10 through the surveillance apparatus 20.

Although contents of the instruction are not particularly limited thereto, the contents may be, for example, a charge and discharge instruction with a charge and discharge pattern in which a charge electric power value [W] or a discharge electric power value [W] is determined along a time axis. In this case, the response data is actually measured data of a charge electric power [W] or a discharge electric power [W] of the energy storage system 30. For example, a measurement sensor included in the energy storage system 30 measures the actually measured data. Then, the actually measured data is transmitted to the request unit 14. The response time is, for example, a time from an instruction transmitting timing to a timing when the charge and discharge pattern is measured.

There is a possibility that owing to the remodeling, a performance of the energy storage system 30 is changed and the response time is changed from a previous one. By verifying whether or not the configuration of the energy storage system 30 is regular according to the detection, it is possible to detect remodeling or the like at an early stage.

### Example 5

In Example 5, the request unit 14 obtains at least one of a storage amount, a discharge amount, an integrated amount [Wh] (including not only a continuously integrated amount but also an integration when charging is switched to discharging on the way) related to charging or discharging, an integrated time related to charging or discharging, and the number of times of cycles related to charging and discharging of energy of the energy storage system 30 from the energy storage system 30 through the surveillance apparatus 20. As an example, it is considered to obtain an integrated amount in a case where a storage operation or a discharge operation is continuously performed for a predetermined time (for example, 10 minutes or 1 hour). The request unit 14 determines to transmit the request to the surveillance apparatus 20 according to the detection of the change of a predetermined level or more from a previous value.

There is a possibility that according to the remodeling, the performance of the energy storage system 30 is changed and the obtained value is changed from a previous one. For example, there is a possibility that a speed of the energy discharge operation (for example, discharge speed) and a speed of the energy storage operation (for example, charge speed) are changed from a previous one. By verifying whether or not the configuration of the energy storage system 30 is regular according to the detection, it is possible to detect remodeling or the like at an early stage.

### Example 6

In Example 6, the request unit 14 obtains, from the surveillance apparatus 20, an elapsed time of a standby state in which the energy storage system 30 does not perform the storage operation (for example, charge operation) or the discharge operation (for example, discharge operation) of energy. The request unit 14 determines to transmit the request to the surveillance apparatus 20 according to detecting that the elapsed time exceeds a predetermined value.

During the remodeling, there is a high possibility that the energy storage system 30 is in the standby state in which the energy storage operation and the energy discharge operation are not performed. In a case where the standby state exceeds a predetermined value, there is a high possibility that the energy storage system 30 is in the remodeling. By verifying whether or not the configuration of the energy storage system 30 is regular according to the detection, it is possible to detect remodeling or the like at an early stage.

Note that, in the present example embodiment, the determination apparatus 10 determines the timing of requesting the object information on the basis of state data indicating a state of the energy storage system 30, but the surveillance apparatus 20 and the energy storage system 30 may determine the timing of transmitting the object information to the determination apparatus 10 on the basis of the state data. In this case, transmission and reception of the state data between the surveillance apparatus 20 and the determination apparatus 10 becomes unnecessary. As a result, a communication burden can be reduced.

In addition, the surveillance apparatus 20 and the energy storage system 30 may determine to transmit the object information to the determination apparatus 10 at “a timing when the request unit 14 determines to transmit the request to the surveillance apparatus 20” by performing the same determination as the request unit 14 on the basis of the same data as that processed by the request unit 14.

Next, an advantageous effect of the present example embodiment will be described.

According to the present example embodiment, the same advantageous effect as the first example embodiment is realized. In addition, according to the present example embodiment, in a case where the state data of the energy storage system 30 diverges from the reference value (for example, a statistical value of the state data of the energy storage system 30 for a predetermined period in the past, a predetermined value, or the like) by a predetermined level or more, it is possible to request the object information and to determine whether or not the configuration of the energy storage system 30 is regular.

In a case where some of the components of the energy storage system 30 are changed (remodeled) to other ones, it is expected that a tendency of the state data is changed from that of the previous ones after the timing. By determining whether or not the configuration of the energy storage system 30 is regular at the timing, it is possible to detect the energy storage system 30 which has the non-regular configuration at an early stage.

In addition, as described in the modification, by determining whether or not the configuration of the energy storage system 30 is regular according to the detection of various events indicating possibility of remodeling, it is possible to detect remodeling or the like at an early stage.

Next, a specific example in which the surveillance system of the first and second example embodiments is applied will be described.

### Specific Example 1

Parties in Specific Example 1 are “business entity doing business using the energy storage system 30 (hereinafter, referred to as “energy business entity”)”, “finance business entity providing funds to a servicer”, or “business entity performing a service of determining whether or not the configuration of the energy storage system 30 is regular (hereinafter, referred to as “surveillance business entity”)”.

The energy business entity raises funds based on a business plan specifying the used energy storage system 30, contents of the service, or the like. The finance business entity provides a predetermined amount of funds to the energy business entity on the basis of a function, a value, safety, and others of the used energy storage system 30.

The finance business entity requests the surveillance business entity to surveil the configuration of the energy storage system 30 used in the business of the energy business entity so as to suppress a decline in the value of the business of the energy business entity and an occurrence of an accident. That is, the finance business entity notifies the surveillance business entity of “the configuration of the energy storage system 30 used in the business” determined between the energy business entity and the finance business entity and requests to surveil whether or not the energy storage system 30 having the configuration is used. In a case of the specific example, “the configuration of the energy storage system 30 used in the business” determined between the energy business entity and the finance business entity is “the configuration of the regular energy storage system 30”.

The determination apparatus 10 of the surveillance business entity registers the regular configuration of the energy storage system 30 associated with the energy business entity and/or the finance business entity (client related to the energy storage system 30).

In addition, the surveillance business entity notifies the finance business entity or the energy business entity of network address information and the like of the determination apparatus 10 and requests to register the network address information in the surveillance apparatus 20.

The energy business entity performs an initial setting on the energy storage system 30 or the surveillance apparatus 20 used in the business according to the request from the surveillance business entity or the finance business entity. For example, the network address information and the like of the determination apparatus 10 may be set to the surveillance apparatus 20 or the identification information of the energy business entity and/or the finance business entity (client related to the energy storage system 30) may be set to the energy storage system 30.

Thereafter, the processes described in the first and second example embodiments are performed between the surveillance apparatus 20 and the energy storage system 30 used by the energy business entity and the determination apparatus 10 of the surveillance business entity. For example, the processes are performed in the flows described with reference to FIGS. 8 to 10.

Note that, a contact address (for example, e-mail address) of the finance business entity may be registered in the determination apparatus 10. The determination apparatus 10 may be configured, when it is detected that the energy storage system 30 has the non-regular configuration, to notify that the energy storage system 30 does not have the regular configuration.

### Specific Example 2

Parties in Specific Example 2 are “manufacturer which manufactures and sells the energy storage system 30” and “client who purchases the energy storage system 30 from the manufacturer and uses the energy storage system”.

In order to safely use the energy storage system 30, the manufacturer prohibits use of units other than regular units. In addition, the manufacturer manages the configuration of the energy storage system 30 even after the selling and gives permission for operation only to the energy storage system 30 determined to have the regular configuration.

The determination apparatus 10 of the manufacturer registers the regular configuration of one or each of the plural energy storage systems 30 which the own company manufactures and sells in the regular information storage unit.

The surveillance apparatus 20 and the energy storage system 30 request setting of address information and the like of the determination apparatus 10 as preparation before use. For example, the client or a worker of the manufacturer performs the setting. Note that, the address information of the determination apparatus 10 may be set from a shipping stage of the surveillance apparatus 20.

Thereafter, the processes described in the first and second example embodiments are performed between the surveillance apparatus 20 and the energy storage system 30 of the client and the determination apparatus 10 of the manufacturer. For example, the processes are performed in the flows described with reference to FIGS. 8 to 10.

Hereinafter, appendixes to examples of reference forms will be added.

1. A determination apparatus including:

an information obtaining unit that obtains first information indicating plural components, included in an energy storage system, associated with each energy storage system;

an object information obtaining unit that obtains object information indicating the plural components included in the energy storage system to be verified; and

a determination unit that determines whether or not a configuration of the energy storage system to be verified is regular on the basis of the first information and the object information.

2. The determination apparatus according to appendix 1,

in which the object information obtaining unit obtains the object information obtained from the energy storage system to be verified by a surveillance apparatus which surveils the energy storage system to be verified.

3. The determination apparatus according to appendix 2, further including:

a request unit that requests the object information from the surveillance apparatus at a predetermined timing.

4. The determination apparatus according to appendix 3,

in which the request unit determines the timing on the basis of state data indicating a state of the energy storage system.

5. The determination apparatus according to appendix 4,

in which the state data includes at least one of an integrated charge electric power amount [Wh] within a predetermined period, an integrated discharge electric power amount [Wh] within a predetermined period, a statistical value of a temperature of the energy storage system within a predetermined period, and a statistical value of a battery voltage of the energy storage system within a predetermined period.

6. The determination apparatus according to appendix 4 or 5,

in which if a value of the state data diverges from a reference value by a predetermined level or more, the request unit requests the object information.

7. The determination apparatus according to appendix 3,

in which the determination unit issues operation permission to the energy storage system on the basis of a determination result of whether regular or not, and

if the operation permission is applied from the energy storage system, the request unit requests the object information from the surveillance apparatus which surveils the energy storage system.

8. The determination apparatus according to appendix 3,

in which the request unit requests the object information from the surveillance apparatus which surveils the energy storage system according to installation of the energy storage system.

9. The determination apparatus according to appendix 3,

in which the request unit regularly requests the object information from the surveillance apparatus which surveils the energy storage system on the basis of a predetermined schedule.

10. The determination apparatus according to appendix 3,

in which the request unit requests the object information from the surveillance apparatus which surveils the energy storage system according to detection of maintenance for the energy storage system.

11. The determination apparatus according to appendix 3,

in which the request unit requests the object information from the surveillance apparatus which surveils the energy storage system according to detection of a part of the energy storage system being replaced.

12. The determination apparatus according to any one of appendixes 1 to 11,

in which the information obtaining unit obtains information for identifying the energy storage system to be verified from the surveillance apparatus which surveils the energy storage system to be verified and obtains the first information corresponding to the energy storage system to be verified from a first information storage unit which stores the first information corresponding to each of plural the energy storage systems.

13. The determination apparatus according to any one of appendixes 1 to 11,

in which the information obtaining unit obtains information for identifying a client from the surveillance apparatus which surveils the energy storage system to be verified and obtains the first information corresponding to the client from a first information storage unit which stores the first information corresponding to each of plural clients.

14. The determination apparatus according to any one of appendixes 1 to 13,

in which the information obtaining unit obtains the first information obtained from the energy storage system to be verified by the surveillance apparatus which surveils the energy storage system to be verified.

15. The determination apparatus according to any one of appendixes 1 to 14,

in which the determination unit determines whether or not the configuration of the energy storage system is regular on the basis of the first information obtained from a first information storage unit which stores the first information associated with each of the plural energy storage systems, the first information obtained from the energy storage system which stores the first information, and the object information obtained from the energy storage system.

16. The determination apparatus according to any one of appendixes 1 to 15,

in which the energy storage system includes a system controller which controls the overall energy storage system, an energy storage unit which stores energy, an energy control unit which controls the energy storage unit, and a power conditioner which performs conversion of DC power/AC power as the plural components.

17. The determination apparatus according to any one of appendixes 1 to 16,

in which if it is determined that the configuration of the energy storage system to be verified is not regular, the determination unit outputs a warning.

18. The determination apparatus according to any one of appendixes 1 to 17,

in which if it is determined that the configuration of the energy storage system to be verified is not regular, the determination unit outputs an instruction of stopping an operation of the energy storage system to be verified.

19. A surveillance apparatus including:

an obtaining unit that obtains object information indicating plural components included in an energy storage system to be verified; and

a communication unit that transmits the object information to an external apparatus.

20. The surveillance apparatus according to appendix 19,

in which the obtaining unit obtains identification information for identifying each of the plural components included in the energy storage system to be verified from each component, and

the communication unit transmits the object information including the identification information to the external apparatus.

21. The surveillance apparatus according to appendix 19,

in which after obtaining an identification number for identifying each of the plural components included in the energy storage system to be verified from each component, the obtaining unit calculates a transmission value by arithmetic on the basis of the identification number, and

the communication unit transmits the object information including the transmission value to the external apparatus.

22. The surveillance apparatus according to appendix 19,

in which the obtaining unit obtains information indicating charge and discharge characteristics obtained from a charge and discharge operation performed by the energy storage system, and

the communication unit transmits the object information including the information indicating the charge and discharge characteristics to the external apparatus.

23. The surveillance apparatus according to any one of appendixes 19 to 22,

in which the obtaining unit obtains the object information at a predetermined timing, and

the communication unit transmits the object information to the external apparatus according to the obtainment by the obtaining unit.

24. The surveillance apparatus according to appendix 23,

in which the obtaining unit determines the timing on the basis of state data indicating a state of the energy storage system.

25. The surveillance apparatus according to appendix 24,

in which the state data includes at least one of an integrated charge electric power amount [Wh] within a predetermined period, an integrated discharge electric power amount [Wh] within a predetermined period, a statistical value of a temperature of the energy storage system within a predetermined period, and a statistical value of a battery voltage of the energy storage system within a predetermined period.

26. The determination apparatus according to appendix 24 or 25,

in which if a value of the state data diverges from a reference value by a predetermined level or more, the obtaining unit obtains the object information.

27. The surveillance apparatus according to appendix 23,

in which if an application of operation permission is received from the energy storage system, the obtaining unit obtains the object information.

28. The surveillance apparatus according to appendix 23,

in which the obtaining unit obtains the object information according to installation of the energy storage system.

29. The surveillance apparatus according to appendix 23,

in which the obtaining unit regularly obtains the object information on the basis of a predetermined schedule.

30. The surveillance apparatus according to appendix 23,

in which the obtaining unit obtains the object information according to detection of maintenance for the energy storage system.

31. The surveillance apparatus according to appendix 23,

in which the obtaining unit obtains the object information according to detection of a part of the energy storage system being replaced.

32. An energy storage system including plural components, and transmitting object information indicating each of the components to an external apparatus at a predetermined timing.

33. The energy storage system according to appendix 32,

in which the energy storage system determines the timing on the basis of state data indicating a state of the energy storage system.

34. The energy storage system according to appendix 33,

in which the state data includes at least one of an integrated charge electric power amount [Wh] within a predetermined period, an integrated discharge electric power amount [Wh] within a predetermined period, a statistical value of a temperature of the energy storage system within a predetermined period, and a statistical value of a battery voltage of the energy storage system within a predetermined period.

35. The determination apparatus according to appendix 33 or 34,

in which if a value of the state data diverges from a reference value by a predetermined level or more, the energy storage system transmits the object information.

36. The energy storage system according to appendix 32,

in which if an application input of operation permission is accepted, the energy storage system transmits the object information.

37. The energy storage system according to appendix 32,

in which the energy storage system transmits the object information according to installation of the energy storage system.

38. The energy storage system according to appendix 32,

in which the energy storage system regularly transmits the object information on the basis of a predetermined schedule.

39. The energy storage system according to appendix 32,

in which the energy storage system transmits the object information according to detection of maintenance for the energy storage system.

40. The energy storage system according to appendix 32,

in which the energy storage system transmits the object information according to detection of a part of the energy storage system being replaced.

41. A surveillance system including the determination apparatus according to any one of appendixes 1 to 18 and the surveillance apparatus according to any one of appendixes 19 to 31.

42. The surveillance system according to appendix 41, further including:

an energy storage system.

43. A determination method performed by a computer, the method including:

an information obtaining step of obtaining first information indicating plural components, included in an energy storage system, associated with each energy storage system;

an object information obtaining step of obtaining object information indicating the plural components included in the energy storage system to be verified; and

a determination step of determining whether or not a configuration of the energy storage system to be verified is regular on the basis of the first information and the object information.

44. A program causing a computer to function as:

an information obtaining unit that obtains first information indicating plural components, included in an energy storage system, associated with each energy storage system;

an object information obtaining unit that obtains object information indicating the plural components included in the energy storage system to be verified; and

a determination unit that determines whether or not a configuration of the energy storage system to be verified is regular on the basis of the first information and the object information.

45. A surveillance method performed by a computer, the method including:

an obtaining step of obtaining object information indicating plural components included in an energy storage system to be verified; and

a communication step of transmitting the object information to an external apparatus.

46. A program causing a computer to function as:

an obtaining unit that obtains object information indicating plural components included in an energy storage system to be verified; and

a communication unit that transmits the object information to an external apparatus.

47. An operation method of an energy storage system performed by a computer of the energy storage system including plural components, the method including:

transmitting object information indicating each of the components to an external apparatus at a predetermined timing.

48. A program causing a computer of an energy storage system including plural components, to function as:

a unit that transmits object information indicating each of the components to an external apparatus at a predetermined timing.

This application claims priority based on Japanese Patent Application No. 2016-140567 filed on Jul. 15, 2016, the disclosure of which is incorporated herein in its entirety.

1. A determination apparatus comprising:
an information obtaining unit that obtains first information indicating a plurality of components, included in an energy storage system, associated with each energy storage system;
an object information obtaining unit that obtains object information indicating the plurality of components included in the energy storage system to be verified; and
a determination unit that determines whether or not a configuration of the energy storage system to be verified is regular on the basis of the first information and the object information.

2. The determination apparatus according to claim 1,
wherein the object information obtaining unit obtains the object information obtained from the energy storage system to be verified by a surveillance apparatus which surveils the energy storage system to be verified.

3. The determination apparatus according to claim 2, further comprising:
a request unit that requests the object information from the surveillance apparatus at a predetermined timing.

4. The determination apparatus according to claim 3,
wherein the request unit determines the timing on the basis of state data indicating a state of the energy storage system.

5. The determination apparatus according to claim 3,
wherein the determination unit issues operation permission to the energy storage system on the basis of a determination result of whether regular or not, and
if the operation permission is applied from the energy storage system, the request unit requests the object information from the surveillance apparatus which surveils the energy storage system.

6. The determination apparatus according to claim 3,
wherein the request unit requests the object information from the surveillance apparatus which surveils the energy storage system according to installation of the energy storage system.

7. The determination apparatus according to claim 3,
wherein the request unit regularly requests the object information from the surveillance apparatus which surveils the energy storage system on the basis of a predetermined schedule.

8. The determination apparatus according to claim 3,
wherein the request unit requests the object information from the surveillance apparatus which surveils the energy storage system according to detection of maintenance for the energy storage system.

9. The determination apparatus according to claim 3,
wherein the request unit requests the object information from the surveillance apparatus which surveils the energy storage system according to detection of a part of the energy storage system being replaced.

10. The determination apparatus according to claim 1,
wherein the information obtaining unit obtains the first information obtained from the energy storage system to be verified by the surveillance apparatus which surveils the energy storage system to be verified.

11. The determination apparatus according to claim 1,
wherein the determination unit determines whether or not the configuration of the energy storage system is regular on the basis of the first information obtained from a first information storage unit which stores the first information associated with each of a plurality of the energy storage systems, the first information obtained from the energy storage system which stores the first information, and the object information obtained from the energy storage system.

12. The determination apparatus according to claim 1,
wherein if it is determined that the configuration of the energy storage system to be verified is not regular, the determination unit outputs a warning.

13. The determination apparatus according to claim 1,
wherein if it is determined that the configuration of the energy storage system to be verified is not regular, the determination unit outputs an instruction of stopping an operation of the energy storage system to be verified.

14. A surveillance apparatus comprising:
an obtaining unit that obtains object information indicating a plurality of components included in an energy storage system to be verified; and
a communication unit that transmits the object information to an external apparatus,
wherein the obtaining unit obtains identification information for identifying each of the plurality of components included in the energy storage system to be verified from each component, and
the communication unit transmits the object information comprising the identification information to the external apparatus.

15. The surveillance apparatus according to claim 14,
wherein after obtaining an identification number for identifying each of the plurality of components included in the energy storage system to be verified from each component, the obtaining unit calculates a transmission value by arithmetic based on the identification number, and
the communication unit transmits the object information comprising the transmission value to the external apparatus.

16. The surveillance apparatus according to claim 14,
wherein the obtaining unit obtains information indicating charge and discharge characteristics obtained from a charge and discharge operation performed by the energy storage system, and
the communication unit transmits the object information comprising the information indicating the charge and discharge characteristics to the external apparatus.

17. The surveillance apparatus according to claim 14,
wherein the obtaining unit obtains the object information at a predetermined timing, and
the communication unit transmits the object information to the external apparatus according to the obtainment by the obtaining unit.

18. The surveillance apparatus according to claim 17,
wherein the obtaining unit determines the timing on the basis of state data indicating a state of the energy storage system.

19. The surveillance apparatus according to claim 18,
wherein if a value of the state data diverges from a reference value by a predetermined level or more, the obtaining unit obtains the object information.

20. The surveillance apparatus according to claim 17,
wherein if an application of operation permission is received from the energy storage system, the obtaining unit obtains the object information.

21. The surveillance apparatus according to claim 17,
wherein the obtaining unit obtains the object information according to installation of the energy storage system.

22. The surveillance apparatus according to claim 17,
wherein the obtaining unit regularly obtains the object information on the basis of a predetermined schedule.

23. The surveillance apparatus according to claim 17,
wherein the obtaining unit obtains the object information according to detection of maintenance for the energy storage system.

24. The surveillance apparatus according to claim 17,
wherein the obtaining unit obtains the object information according to detection of a part of the energy storage system being replaced.

25. An energy storage system comprising a plurality of components, and transmitting object information indicating each of the components to an external apparatus at a predetermined timing.

26. The energy storage system according to claim 25,
wherein the energy storage system determines the timing on the basis of state data indicating a state of the energy storage system.

27. The energy storage system according to claim 26,
wherein if a value of the state data diverges from a reference value by a predetermined level or more, the energy storage system transmits the object information.

28. The energy storage system according to claim 25,
wherein if an application input of operation permission is accepted, the energy storage system transmits the object information.

29. The energy storage system according to claim 25,
wherein the energy storage system transmits the object information according to installation of the energy storage system.

30. The energy storage system according to claim 25,
wherein the energy storage system regularly transmits the object information on the basis of a predetermined schedule.

31. The energy storage system according to claim 25,
wherein the energy storage system transmits the object information according to detection of maintenance for the energy storage system.

32. The energy storage system according to claim 25,
wherein the energy storage system transmits the object information according to detection of a part of the energy storage system being replaced.

33. A determination method performed by a computer, the method comprising:
an information obtaining step of obtaining first information indicating a plurality of components, included in an energy storage system, associated with each energy storage system;
an object information obtaining step of obtaining object information indicating the plurality of components included in the energy storage system to be verified; and
a determination step of determining whether or not a configuration of the energy storage system to be verified is regular on the basis of the first information and the object information.

34. A surveillance method performed by a computer, the method comprising:
an obtaining step of obtaining object information indicating a plurality of components included in an energy storage system to be verified; and
a communication step of transmitting the object information to an external apparatus.

35. A non-transitory storage medium storing a program causing a computer to function as:
an obtaining unit that obtains object information indicating a plurality of components included in an energy storage system to be verified; and
a communication unit that transmits the object information to an external apparatus.

36. An operation method of an energy storage system performed by a computer of the energy storage system comprising a plurality of components, the method comprising:
transmitting object information indicating each of the components to an external apparatus at a predetermined timing.

37. A non-transitory storage medium storing a program causing a computer of an energy storage system comprising a plurality of components, to function as:
a unit that transmits object information indicating each of the components to an external apparatus at a predetermined timing.
